(19) United States
(12) Patent Application Publication
(10) Pub. No.: US 2025/0261004 A1
(43) Pub. Date: Aug. 14, 2025

(54) COMMUNICATION METHOD

(71) Applicant: KYOCERA Corporation, Kyopto (JP)

(72) Inventor: Masato FUJISHIRO, Yokohama-shi (JP)

(73) Assignee: KYOCERA Corporation, Kyoto (JP)

(21) Appl. No.: 19/193,733

(22) Filed: Apr. 29, 2025

Related U.S. Application Data
(63) Continuation of application No. PCT/JP2023/039397, filed on Nov. 1, 2023.

(30) Foreign Application Priority Data
Nov. 1, 2022 (CN) 2022-175872

(51) Int. Cl. H04W 24/02

(52) U.S. Cl. CPC H04W 24/02

(57) ABSTRACT

A communication method for applying an artificial intelligence or machine learning (AI/ML) technology to wireless communication between a user equipment and a network in a mobile communication system includes receiving, by the user equipment, environment information from the network, the environment information indicating an communication environment of a coverage area corresponding to a location of the user equipment, and performing, by the user equipment, AI/ML processing among learning processing and/or inference processing using an AI/ML model, based on the environment information.

### RELATED APPLICATIONS

The present application is a continuation based on PCT Application No. PCT/JP2023/039397, filed on Nov. 1, 2023, which claims the benefit of Japanese Patent Application No. 2022-175872 filed on Nov. 1, 2022. The content of which is incorporated by reference herein in their entirety.

### TECHNICAL FIELD

The present disclosure relates to a communication method used in a mobile communication system.

### BACKGROUND

In the Third Generation Partnership Project (3GPP) (registered trade name, the same shall applies hereinafter), which is a standardization project for mobile communication systems, a study is underway to apply an artificial intelligence or machine learning (also referred to as AI/ML) technology to wireless communication (air interface) in the mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In a first aspect, a communication method is a communication method for applying an artificial intelligence or machine learning (AI/ML) technology to wireless communication between a user equipment and a network in a mobile communication system, the method including receiving, by a user equipment, environment information from a network, the environment information indicating an communication environment of a coverage area corresponding to a location of the user equipment, and performing, by the user equipment, AI/ML processing among learning processing and/or inference processing using an AI/ML model, based on the environment information.

In a second aspect, a communication method is a communication method for applying an artificial intelligence or machine learning (AI/ML) technology to wireless communication between a user equipment and a network in a mobile communication system, the method including transmitting, by a user equipment, model information to a network, the model information indicating attributes of an AI/ML model included in the user equipment, and receiving, by the user equipment, information indicating whether the user equipment is capable of using the AI/ML model, from the network.

In a third aspect, a communication method is a communication method for applying an artificial intelligence or machine learning (AI/ML) technology to wireless communication between a user equipment and a network in a mobile communication system, the method including receiving, by a user equipment, configuration information from a network, the configuration information being configured to configure a transmission path used to transfer an AI/ML model from the network to the user equipment, and receiving, by the user equipment, the AI/ML model from the network via the transmission path.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a functional block configuration of an AI/ML technology (machine learning technology) in the mobile communication system according to an embodiment.

FIG. 7 is a diagram illustrating an overview of operations relating to each operation scenario according to an embodiment.

FIG. 8 is a diagram illustrating a first operation scenario according to an embodiment.

FIG. 9 is a diagram illustrating a first example of reducing CSI-RSs according to an embodiment.

FIG. 10 is a diagram illustrating a second example of reducing the CSI-RSs according to an embodiment.

FIG. 11 is an operation flow diagram illustrating a first operation pattern relating to the first operation scenario according to an embodiment.

FIG. 12 is an operation flow diagram illustrating a second operation pattern relating to the first operation scenario according to an embodiment.

FIG. 13 is an operation flow diagram illustrating a third operation pattern relating to the first operation scenario according to an embodiment.

FIG. 14 is a diagram illustrating a second operation scenario according to an embodiment.

FIG. 15 is an operation flow diagram illustrating an operation example relating to the second operation scenario according to an embodiment.

FIG. 16 is a diagram illustrating a third operation scenario according to an embodiment.

FIG. 17 is an operation flow diagram illustrating an operation example relating to the third operation scenario according to an embodiment.

FIG. 18 is a diagram illustrating a first operation pattern relating to model transfer according to an embodiment.

FIG. 19 is a diagram illustrating an example of a configuration message including models and additional information according to an embodiment.

FIG. 20 is a diagram illustrating a second operation pattern relating to model transfer according to an embodiment.

FIG. 21 is a diagram illustrating a third operation pattern relating to model transfer according to an embodiment.

FIG. 22 is a diagram illustrating an example of model management according to an embodiment.

FIG. 23 is a diagram illustrating details of model management according to an embodiment.

FIG. 24 is a diagram illustrating an example of a UE side model included in the UE according to an embodiment.

FIG. 25 is a diagram illustrating another example of the UE side model included in the UE according to an embodiment.

FIG. 26 is a diagram illustrating an operation example of a first operation pattern in consideration of an area communication environment according to an embodiment.

FIG. 27 is a diagram illustrating an operation example of a second pattern in consideration of the area communication environment according to an embodiment.

FIG. 28 is a diagram for describing a transmission path used for the model transfer according to an embodiment.

FIG. 29 is a diagram illustrating an operation example for a configuration of the transmission path used for the model transfer according to an embodiment.

### DESCRIPTION OF EMBODIMENTS

The present disclosure provides a communication method to enable the AI/ML technology to be leveraged in the mobile communication system.

A mobile communication system according to an embodiment is described with reference to the drawings. In the description of the drawings, the same or similar parts are denoted by the same or similar reference signs.

### (1) Configuration of Mobile Communication System

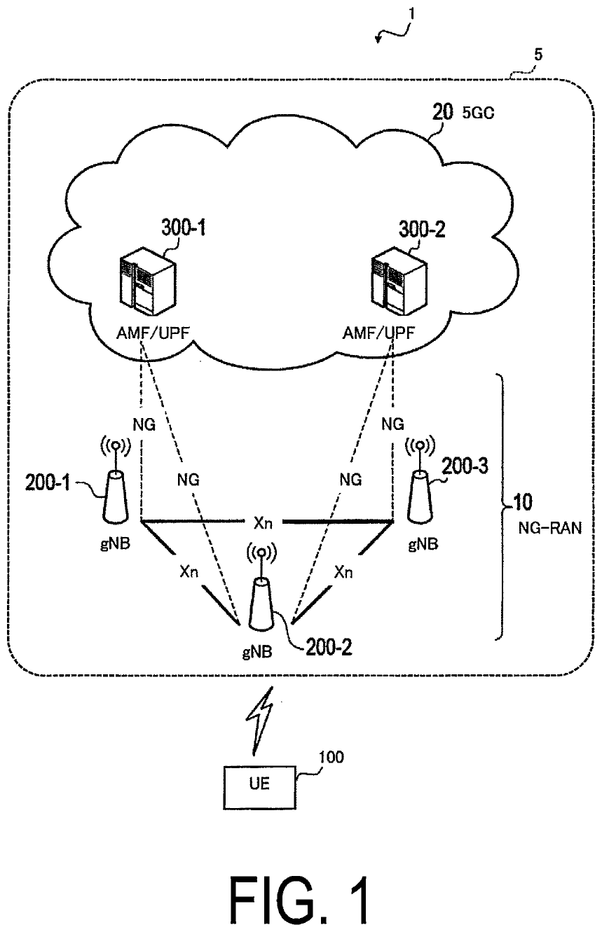

First, a configuration of a mobile communication system according to an embodiment is described. FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1. The UE 100 performs wireless communication with the network 5.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

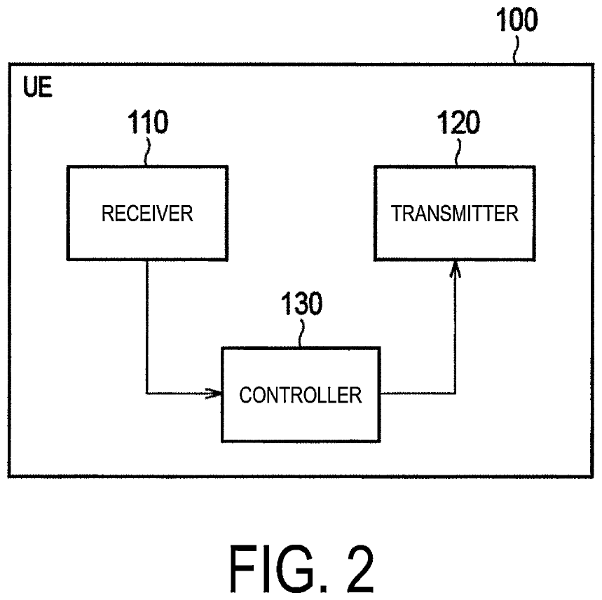

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. The operations of the UE 100 described above and below may also be performed under the control of the controller 130. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

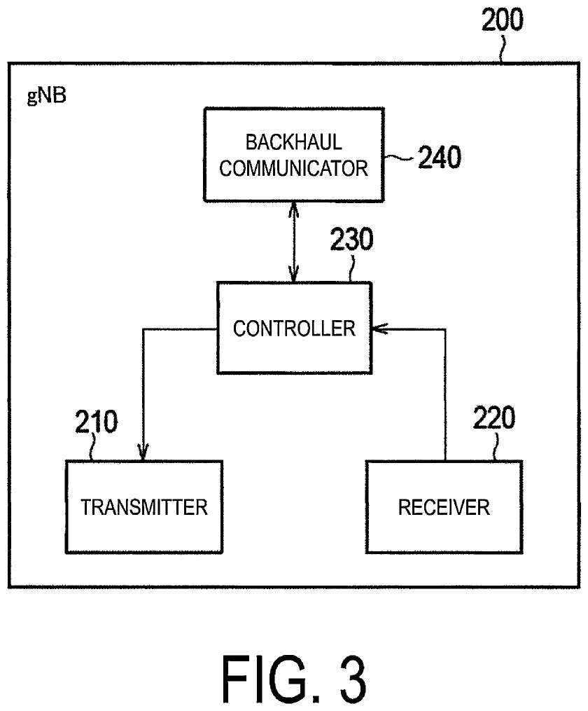

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a communicator that performs wireless communication with the UE 100. The backhaul communicator 240 constitutes a network communicator that performs communication with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. The operations of the gNB 200 described above and below may also be performed under the control of the controller 130. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a central unit (CU) and a distributed unit (DU) (i.e., functions are divided), and the two units may be connected via an F1 interface, which is a fronthaul interface.

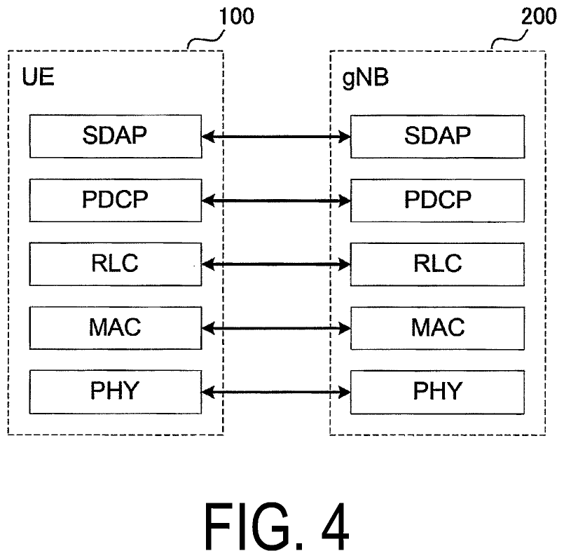

FIG. 4 is a diagram illustrating a configuration of a protocol stack of a radio interface of a user plane handling data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A cyclic redundancy code (CRC) parity bit scrambled by the RNTI is added to the DCI transmitted from the gNB 200.

In NR, the UE 100 can use a bandwidth narrower than a system bandwidth (that is, a cell bandwidth). The gNB 200 configures a bandwidth part (BWP) consisting of consecutive physical resource blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for QoS (Quality of Service) control by the core network, and radio bearers, which are units for QoS control by the access stratum (AS). Note that, when the RAN is connected to the EPC, the SDAP need not be provided.

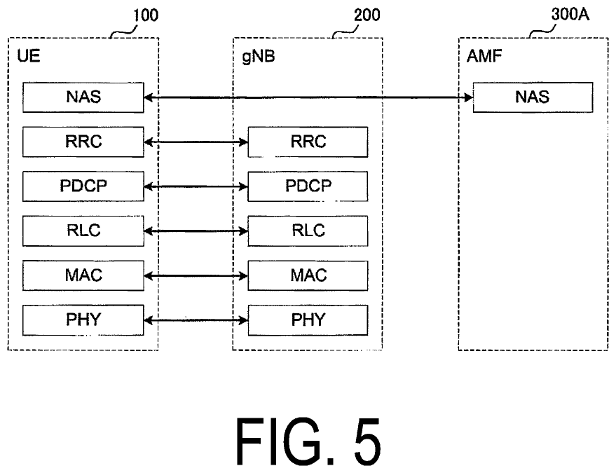

FIG. 5 is a diagram illustrating a configuration of a protocol stack of a radio interface of a control plane handling signaling (a control signal).

The protocol stack of the radio interface of the control plane includes a radio resource control (RRC) layer and a non-access stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as an Access Stratum (AS).

### (2) Overview of AI/ML Technology

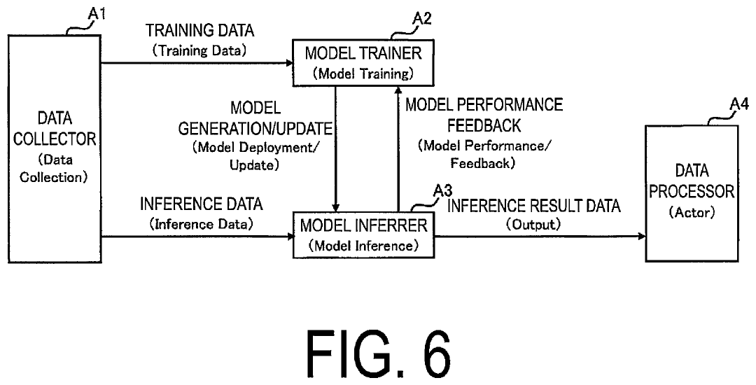

In the embodiment, an AI/ML Technology will be described. FIG. 6 is a diagram illustrating a functional block configuration of the AI/ML technology in the mobile communication system 1 according to the embodiment.

The functional block configuration illustrated in FIG. 6 includes a data collector A1, a model trainer A2, a model inferrer A3, and a data processor A4.

The data collector A1 collects input data, specifically, training data and inference data, and outputs the training data to the model trainer A2 and outputs the inference data to the model inferrer A3. The data collector A1 may acquire data in the device in which the data collector A1 is provided, as input data. The data collector A1 may acquire, as the input data, data in another apparatus.

The model trainer A2 performs model training. To be specific, the model trainer A2 optimizes parameters for the training model (hereinafter also referred to as a “model” or an “AI/ML model”) by machine learning using the training data, derives (generates or updates) a trained model, and outputs the trained model to the model inferrer A3. The model is data-driven algorithm in which a set of outputs is generated based on a set of inputs through application of the AI/ML technology. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. Reinforcement learning is a method of assigning a score to an output result and learning a method of maximizing the score.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. Here, various techniques for the model are used, such as linear regression analysis, neural network, and decision tree analysis. The above “y=ax+b” can be considered as a kind of the linear regression analysis. The model inferrer A3 may perform model performance feedback to the model trainer A2.

The data processor A4 receives the inference result data and performs processing that utilizes the inference result data.

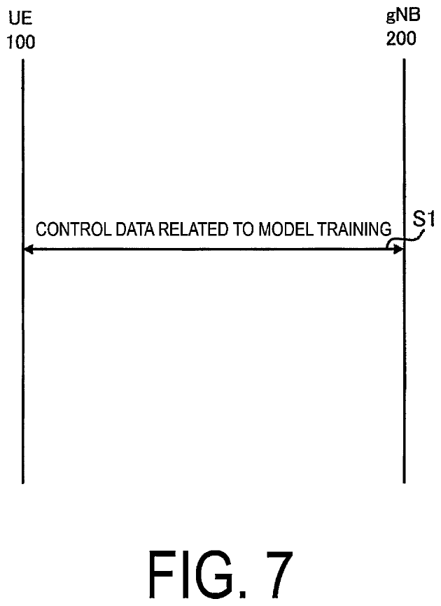

FIG. 7 is a diagram illustrating an overview of operations relating to each operation scenario according to an embodiment. In FIG. 7, one of the UE 100 and the gNB 200 corresponds to a first communication apparatus, and the other corresponds to a second communication apparatus.

In step S1, the UE 100 transmits or receives control data related to the AI/ML technology to or from the gNB 200. The control data may be an RRC message that is RRC layer (i.e., layer 3) signaling. The control data may be a MAC Control Element (CE) that is MAC layer (i.e., layer 2) signaling. The control data may be downlink control information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### (3) Operation Scenario Example

An operation scenario example according to the embodiment will be described.

### (3.1) First Operation Scenario

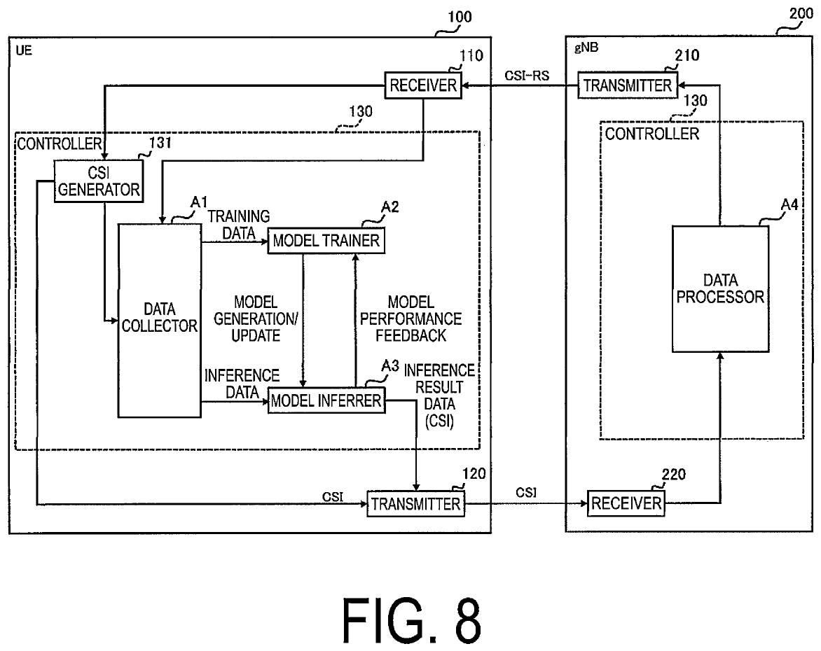

FIG. 8 is a diagram illustrating a first operation scenario according to an embodiment. In the first operation scenario, the data collector A1, the model trainer A2, and the model inferrer A3 are arranged in the ULE 100 (e.g., the controller 130), and the data processor A4 is arranged in the gNB 200 (e.g., the controller 230). In other words, model training and model inference are performed on the UE 100 side.

In the first operation scenario, the AI/ML technology is introduced into channel state information (CSI) feedback from the UE 100 to the gNB 200. The CSI (CSI feedback information) transmitted (fed back) from the UE 100 to the gNB 200 is information related to a downlink channel state between the UE 100 and the gNB 200. The CSI includes at least one selected from the group consisting of a channel quality indicator (CQI), a precoding matrix indicator (PMI), and a rank indicator (RI). The gNB 200 performs, for example, downlink scheduling based on the CSI feedback from the UE 100.

The gNB 200 transmits a reference signal for the UE 100 to estimate a downlink channel state. Such a reference signal may be, for example, a CSI reference signal (CSI-RS). Such a reference signal may also be a demodulation reference signal (DMRS). For example, it is assumed that the reference signal is a CSI-RS.

First, in the model training, the UE 100 (receiver 110) receives a first reference signal from the gNB 200 by using a first resource. Then, the UE 100 (model trainer A2) derives a trained model for inferring CSI from the reference signal by using training data including the first reference signal. Such a first reference signal may be referred to as a full CSI-RS.

For example, the UE 100 (CSI generator 131) performs channel estimation by using the reception signal (CSI-RS) received by the receiver 110 from the gNB 200, and generates CSI. The UE 100 (transmitter 120) transmits the generated CSI to the gNB 200. The model trainer A2 performs model training by using a plurality of sets of the reception signal (CSI-RS) and the CSI as the training data to derive a trained model for inferring the CSI from the reception signal (CSI-RS).

Second, in the model inference, the UE 100 (receiver 110) receives a second reference signal from the gNB 200 by using a second resource that is less than the first resource. Then, the UE 100 (model inferrer A3) uses the trained model to infer the CSI as the inference result data from inference data including the second reference signal. In the description of the first operation scenario, such a second reference signal may be referred to as a partial CSI-RS or a punctured CSI-RS.

For example, the UE 100 (model inferrer A3) uses the reception signal (CSI-RS) received by the receiver 110 from the gNB 200 as the inference data, and infers the CSI from the reception signal (CSI-RS) by using the trained model. The UE 100 (transmitter 120) transmits the inferred CSI to the gNB 200.

This enables the UE 100 to feed back accurate (complete) CSI to the gNB 200 from a small number of CSI-RSs (partial CSI-RSs) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

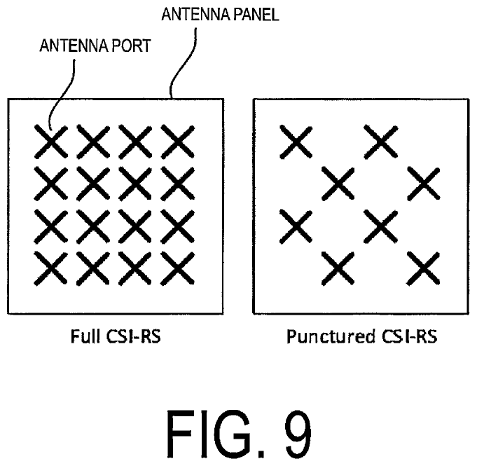

FIG. 9 is a diagram illustrating a first example of reducing CSI-RSs according to an embodiment. In the first example, the gNB 200 reduces the number of antenna ports for transmitting the CSI-RS. For example, the gNB 200 transmits the CSI-RS from all antenna ports of the antenna panel in a mode in which the UE 100 performs the model training. On the other hand, in the mode in which the UE 100 performs model inference, the gNB 200 reduces the number of antenna ports for transmitting the CSI-RSs, and transmits the CSI-RSs from half the antenna ports of the antenna panel. Note that the antenna port is an example of the resource. This can reduce the overhead, improve a utilization efficiency of the antenna ports, and give an effect of power consumption reduction.

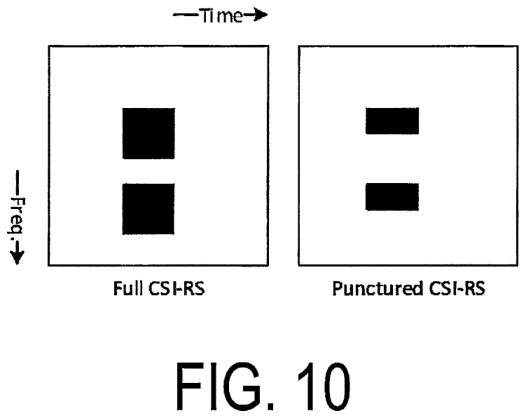

FIG. 10 is a diagram illustrating a second example of reducing the CSI-RSs according to an embodiment. In the second example, the gNB 200 reduces the number of radio resources for transmitting the CSI-RSs, specifically, the number of time-frequency resources. For example, the gNB 200 transmits the CSI-RS by using a predetermined time-frequency resource in a mode in which the UE 100 performs the model training. On the other hand, in a mode in which the UE 100 performs the model inference, the gNB 200 transmits the CSI-RS using a smaller amount of time-frequency resources than predetermined time-frequency resources. This can reduce the overhead, improve a utilization efficiency of the radio resources, and give an effect of power consumption reduction.

A first operation pattern relating to the first operation scenario is described. In the first operation pattern, the gNB 200 transmits a switching notification as the control data to the UE 100, the switching notification providing notification of mode switching between a mode for performing the model training (hereinafter, also referred to as a “training mode”) and a mode for performing model inference (hereinafter, also referred to as an “inference mode”). The UE 100 receives the switching notification and performs the mode switching between the training mode and the inference mode. This enables the mode switching to be appropriately performed between the training mode and the inference mode. The switching notification may be configuration information to configure a mode for the UE 100. The switching notification may be also a switching command for indicating to the UE 100 the mode switching.

In the first operation pattern, when the model training is completed, the UE 100 transmits a completion notification as the control data to the gNB 200, the completion notification indicating that the model training is completed. The gNB 200 receives the completion notification. This enables gNB 200 to grasp that the model training is completed on the UE 100 side.

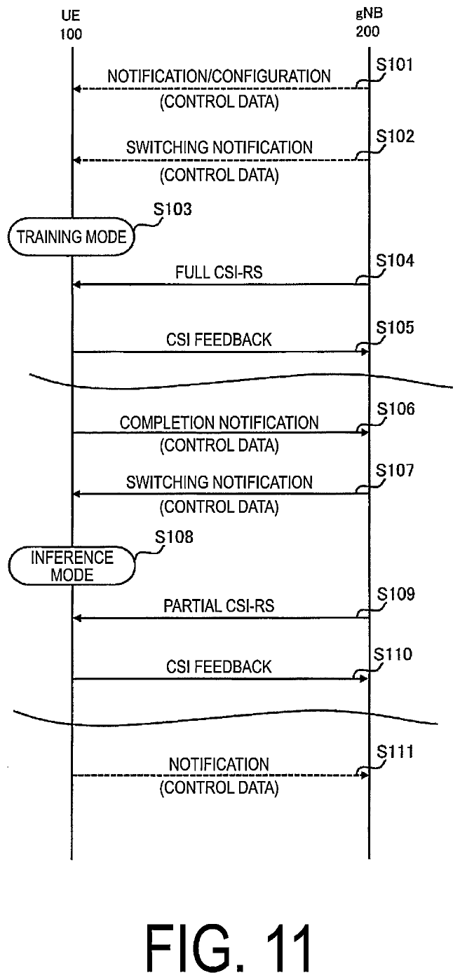

FIG. 11 is an operation flow diagram illustrating the first operation pattern relating to the first operation scenario according to an embodiment. This flow may be performed after the UE 100 establishes an RRC connection to the cell of the gNB 200. Note that in the operation flow described below, dashed lines indicate steps which may be omitted.

In step S101, the gNB 200 may notify the UE 100 of or configure for the UE, as the control data, an input data pattern in the inference mode, for example, a transmission pattern (puncture pattern) of the CSI-RS in the inference mode. For example, the gNB 200 notifies the UE 100 of the antenna port and/or the time-frequency resource for transmitting or not transmitting the CSI-RS in the inference mode.

In step S102, the gNB 200 may transmit a switching notification for starting the training mode to the UE 100.

In step S103, the UE 100 starts the training mode.

In step S104, the gNB 200 transmits a full CSI-RS. The UE 100 receives the full CSI-RS and generates CSI based on the received CSI-RS. In the training mode, the UE 100 may perform supervised learning using the received CSI-RS and CSI corresponding to the received CSI-RS. The UE 100 may derive and manage a training result (trained model) per communication environment of the UE 100, for example, per reception quality (RSRP, RSRQ, or SINR) and/or migration speed.

In step S105, the UE 100 transmits (feeds back) the generated CSI to the gNB 200.

Thereafter, in step S106, when the model training is completed, the UE 100 transmits a completion notification indicating that the model training is completed to the gNB 200. The UE 100 may transmit the completion notification to the gNB 200 when the derivation (generation or update) of the trained model is completed. Here, the UE 100 may transmit a notification indicating that learning is completed per communication environment (e.g., migration speed and reception quality) of the UE 100 itself. In this case, the UE 100 includes, in the notification, information indicating for which communication environment the completion notification is.

In step S107, the gNB 200 transmits, to the UE 100, a switching information notification for switching from the training mode to the inference mode.

In step S108, the UE 100 switches from the training mode to the inference mode in response to receiving the switching notification in step S107.

In step S109, the gNB 200 transmits a partial CSI-RS. Once receiving the partial CSI-RS, the UE 100 uses the trained model to infer CSI from the received CSI-RS. The UE 100 may select a trained model corresponding to the communication environment of the UE 100 itself from among trained models managed per communication environment, and may infer the CSI using the selected trained model.

In step S110, the UE 100 transmits (feeds back) the inferred CSI to the gNB 200.

In step S111, when the UE 100 determines that the model training is necessary, the UE 100 may transmit a notification as the control data to the gNB 200, the notification indicating that the model training is necessary. For example, the UE 100 considers that accuracy of the inference result cannot be guaranteed and transmits the notification to the gNB 200 when the UE 100 moves, the migration speed of the UE 100 changes, the reception quality of the UE 100 changes, the cell in which the UE exists changes, or the bandwidth part (BWP) the UE 100 uses for communication changes.

A second operation pattern relating to the first operation scenario is described. The second operation pattern may be used together with the above-described operation pattern. In the second operation pattern, the gNB 200 transmits a completion condition notification as the control data to the UE 100, the completion condition notification indicating a completion condition of the model training. The UE 100 receives the completion condition notification and determines completion of the model training based on the completion condition notification. This enables the UE 100 to appropriately determine the completion of the model training. The completion condition notification may be configuration information to configure the completion condition of the model training for the UE 100. The completion condition notification may be included in the switching notification providing notification of (indicating) switching to the training mode.

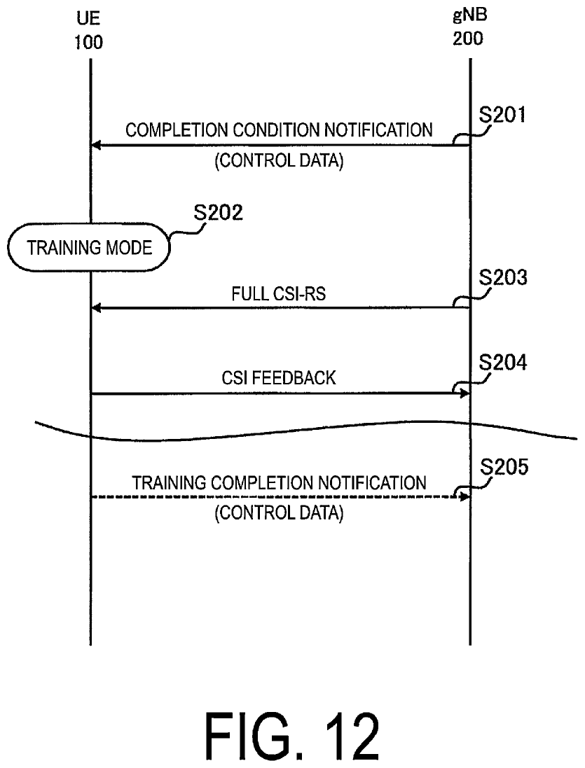

FIG. 12 is an operation flow diagram illustrating the second operation pattern relating to the first operation scenario according to an embodiment.

In step S201, the gNB 200 transmits the completion condition notification as the control data to the UE 100, the completion condition notification indicating the completion condition of the model training. The completion condition notification may include at least one selected from the group consisting of the following pieces of completion condition information.
Acceptable error range for correct answer data:
   For example, adopted is an acceptable range of an error between the CSI generated by using a normal CSI feedback calculation method and the CSI inferred by the model inference. At a stage where the learning has progressed to some extent, the UE 100 can infer the CSI by using the trained model at that point in time, compare the CSI with the correct CSI, and determine that the learning is completed based on that the error is within the acceptable range.
The number of pieces of training data:
   The number of pieces of data used for learning. For example, the number of received CSI-RSs corresponds to the number of pieces of training data. The UE 100 can determine that the learning is completed based on that the number of received CSI-RSs in the training mode reaches the number of pieces of training data indicated by a notification (configuration).
The number of learning trials:
   The number of times the model training is performed using the training data. The UE 100 can determine that the learning is completed based on that the number of times of the learning in the training mode reaches the number of times indicated by a notification (configuration).
Output score threshold value:
   For example, a score in reinforcement learning. The UE 100 can determine that the learning is completed based on that the score reaches the score indicated by a notification (configuration).

The UE 100 continues the learning based on the full CSI-RS until determining that the learning is completed (step S203, S204).

In step S205, the UE 100, when determining that the model training is completed, may transmit a completion notification indicating that the model training is completed to the gNB 200.

A third operation pattern relating to the first operation scenario is described. The third operation pattern may be used together with the above-described operation patterns. When the accuracy of the CSI feedback is desired to be increased, not only the CSI-RS but also other types of data, for example, reception characteristics of a physical downlink shared channel (PDSCH) can be used as the training data and the inference data. In the third operation pattern, the gNB 200 transmits data type information as the control data to the UE 100, the data type information designating at least a type of data used as the training data. In other words, the gNB 200 designates what is to be the training data/inference data (type of input data) with respect to the UE 100. The UE 100 receives the data type information and performs the model training using the data of the designated data type. This enables the UE 100 to perform appropriate model training.

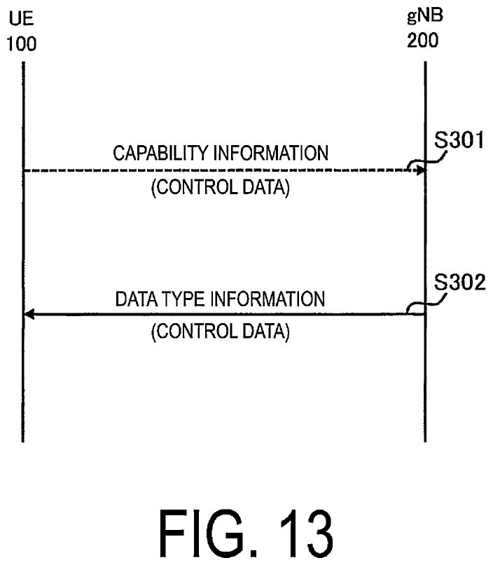

FIG. 13 is an operation flow diagram illustrating the third operation pattern relating to the first operation scenario according to an embodiment.

In step S301, the UE 100 may transmit capability information as the control data to the gNB 200, the capability information indicating which type of input data the UE 100 can handle in the machine learning. Here, the UE 100 may further transmit a notification indicating additional information such as the accuracy of the input data.

In step S302, the UE 100 transmits the data type information to the gNB 200. The data type information may be configuration information to configure a type of the input data for the UE 100. Here, the type of the input data may be the reception quality and/or UE migration speed for the CSI feedback. The reception quality may be reference signal received power (RSRP), reference signal received quality (RSRQ), signal-to-interference-plus-noise ratio (SINR), bit error rate (BER), block error rate (BLER), analog-to-digital converter output waveform, or the like.

Note that when UE positioning to be described below is assumed, the type of the input data may be position information (latitude, longitude, and altitude) of Global Navigation Satellite System (GNSS), RF fingerprint (cell ID, reception quality thereof, and the like), angle of arrival (AoA) of reception signal, reception level/reception phase/reception time difference (OTDOA) for each antenna, roundtrip time, and reception information of short-range wireless communication such as a wireless Local Area Network (LAN).

The gNB 200 may designate the type of the input data independently for each of the training data and the inference data. The gNB 200 may designate the type of input data independently for each of the CSI feedback and the UE positioning.

### (3.2) Second Operation Scenario

A second operation scenario is described mainly on differences from the first operation scenario. The first operation scenario has mainly described the downlink reference signal (that is, downlink CSI estimation). The second operation scenario describes an uplink reference signal (that is, uplink CSI estimation). In the description of the second operation scenario, assume that the uplink reference signal is a sounding reference signal (SRS), but may be an uplink DMRS or the like.

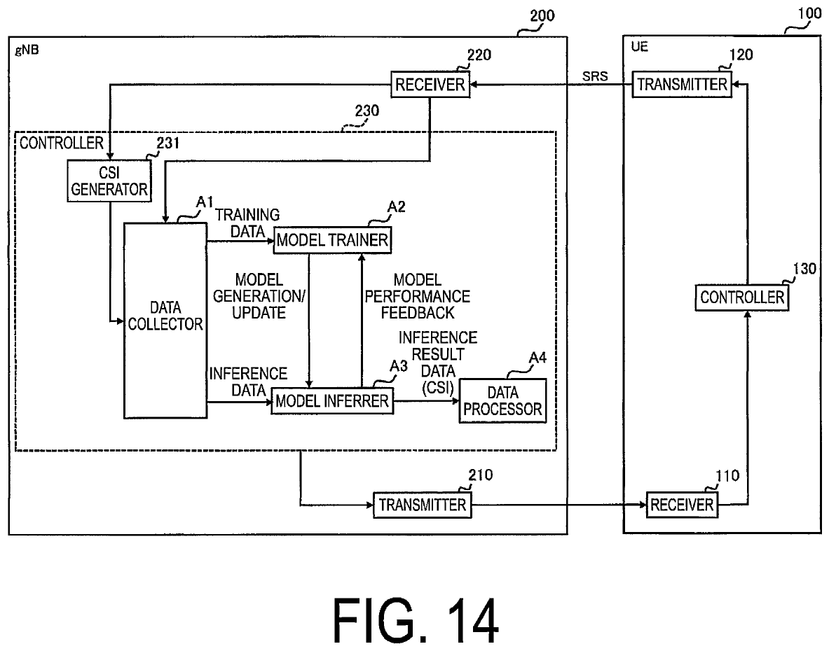

FIG. 14 is a diagram illustrating the second operation scenario according to an embodiment. In the second operation scenario, the data collector A1, the model trainer A2, the model inferrer A3, and the data processor A4 are arranged in the gNB 200 (e.g., the controller 230). In other words, the model training and the model inference are performed on the gNB 200 side.

In the second operation scenario, the AI/ML technology is introduced into the CSI estimation performed by the gNB 200 based on the SRS from the UE 100. Therefore, the gNB 200 (e.g., the controller 230) includes a CSI generator 231 that generates CSI based on the SRS received by the receiver 220 from the UE 100. The CSI is information indicating an uplink channel state between the UE 100 and the gNB 200. The gNB 200 (e.g., the data processor A4) performs, for example, uplink scheduling based on the CSI generated based on the SRS.

First, in the model training, the gNB 200 (receiver 220) receives a first reference signal from the UE 100 by using a first resource. Then, the gNB 200 (model trainer A2) derives a trained model for inferring CSI from the reference signal (SRS) by using training data including the first reference signal. In the description of the second operation scenario, such a first reference signal may be referred to as a full SRS.

For example, the gNB 200 (CSI generator 231) performs channel estimation by using the reception signal (SRS) received by the receiver 220 from the UE 100, and generates CSI. The model trainer A2 performs model training by using a plurality of sets of the reception signal (SRS) and the CSI as the training data to derive a trained model for inferring the CSI from the reception signal (SRS).

Second, in the model inference, the gNB 200 (receiver 220) receives a second reference signal from the UE 100 by using a second resource that is less than the first resource. Then, the UE 100 (model inferrer A3) uses the trained model to infer the CSI as the inference result data from inference data including the second reference signal. In the description of the second operation scenario, such a second reference signal may be referred to as a partial SRS or a punctured SRS. For a puncture pattern of the SRS, the pattern the same as and/or similar to that in the first operation scenario can be used (see FIGS. 9 and 10).

For example, the gNB 200 (model inferrer A3) uses the reception signal (SRS) received by the receiver 220 from the UE 100 as the inference data, and infers the CSI from the reception signal (SRS) by using the trained model.

This enables the gNB 200 to generate accurate (complete) CSI from a small number of SRSs (partial SRSs) received from the UE 100. For example, the UE 100 may reduce (puncture) the SRS when intended for overhead reduction. The gNB 200 can cope with a situation in which a radio situation deteriorates and some SRSs cannot be normally received.

In such an operation scenario, “CSI-RS”, “gNB 200”, and “UE 100” in the operation of the first operation scenario described above can be read as “SRS”, “UE 100”, and “gNB 200”, respectively.

In the second operation scenario, the gNB 200 transmits reference signal type information as the control data to the UE 100, the reference signal type information indicating a type of either the first reference signal (full SRS) or the second reference signal (partial SRS) to be transmitted by the UE 100. The UE 100 receives the reference signal type information and transmits the SRS designated by the gNB 200 to the gNB 200. This can cause the UE 100 to transmit an appropriate SRS.

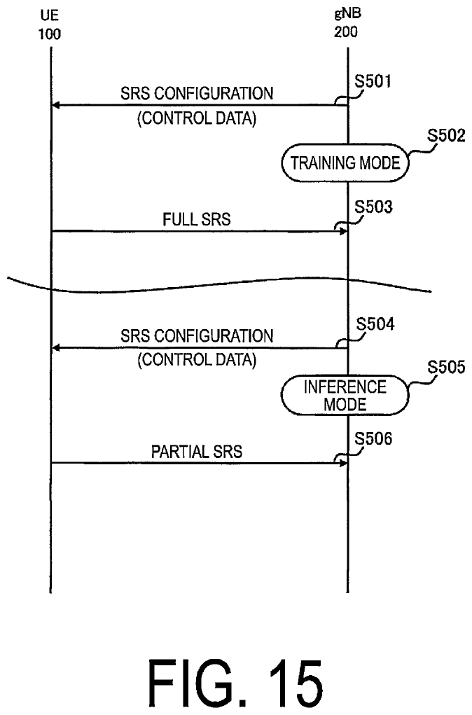

FIG. 15 is an operation flow diagram illustrating an operation example relating to the second operation scenario according to an embodiment.

In step S501, the gNB 200 performs SRS transmission configuration for the UE 100.

In step S502, the gNB 200 starts the training mode.

In step S503, the UE 100 transmits the full SRS to the gNB 200 in accordance with the configuration in step S501. The gNB 200 receives the full SRS and performs model training for channel estimation.

In step S504, the gNB 200 specifies the transmission pattern (puncture pattern) of the SRS to be input as the inference data to the trained model, and configures the specified SRS transmission pattern for the UE 100.

In step S505, the gNB 200 transitions to the inference mode and starts the model inference using the trained model.

In step S506, the UE 100 transmits the partial SRS in accordance with the SRS transmission configuration in step S504. When the gNB 200 inputs the SRS as the inference data to the trained model to obtain a channel estimation result, the gNB 200 performs uplink scheduling (e.g., control of uplink transmission weight and the like) of the UE 100 by using the channel estimation result. Note that when the inference accuracy by way of the trained model deteriorates, the gNB 200 may reconfigure so that the UE 100 transmits the full SRS.

### (3.3) Third Operation Scenario

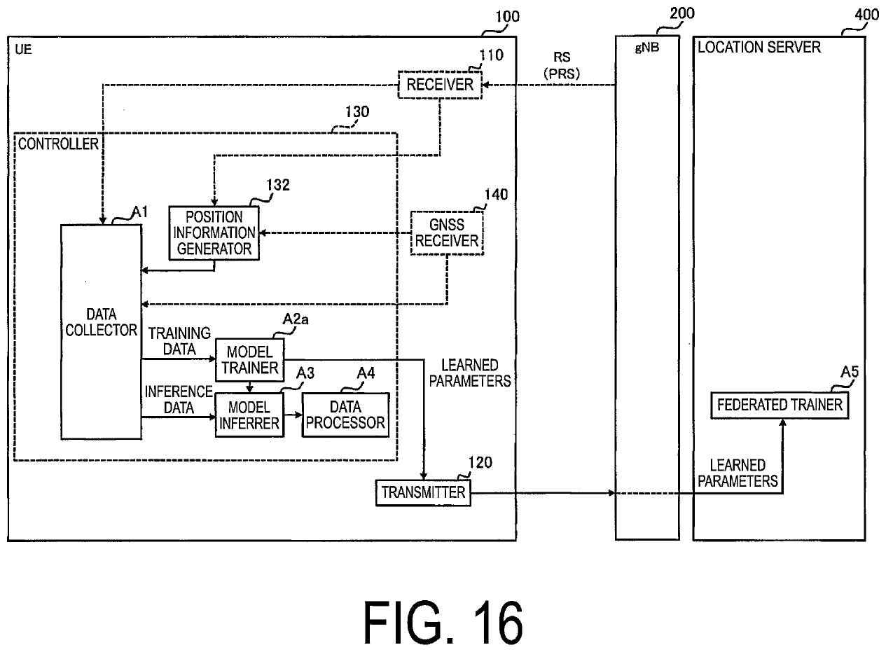

A third operation scenario is described mainly on differences from the first and second operation scenarios. The third operation scenario is an embodiment in which position estimation of the UE 100 (so-called UE positioning) is performed by using federated learning. FIG. 16 is a diagram illustrating the third operation scenario according to an embodiment. In an application example of such federated learning, for example, the following procedure is performed.

First, a location server 400 transmits a model to the UE 100.

Second, the UE 100 performs model training on the UE 100 (model trainer A2) side using the data in the UE 100. The data in the UE 100 may be, for example, a positioning reference signal (PRS) received by the UE 100 from the gNB 200 and/or output data from the GNSS reception device 140. The data in the UE 100 may include position information (including latitude and longitude) generated by the position information generator 132 based on the reception result of the PRS and/or the output data from the GNSS reception device 140.

Third, the UE 100 applies the trained model, which is the training result, to the UE 100 (model inferrer A3) and transmits variable parameters included in the trained model (hereinafter also referred to as “learned parameters”) to the location server 400. In the above example, the optimized a (slope) and b (intercept) correspond to the learned parameters.

Fourth, the location server 400 (federated trainer A5) collects the learned parameters from a plurality of UEs 100 and integrates these parameters. The location server 400 may transmit the trained model obtained by the integration to the UE 100. The location server 400 can estimate the position of the UE 100 based on the trained model obtained by the integration and a measurement report from the UE 100.

In the third operation scenario, the gNB 200 transmits trigger configuration information as the control data to the UE 100, the trigger configuration information configuring a transmission trigger condition for the UE 100 to transmit the learned parameters. The UE 100 receives the trigger configuration information and transmits the learned parameters to the gNB 200 (location server 400) when the configured transmission trigger condition is satisfied. This enables the UE 100 to transmit the learned parameters at an appropriate timing.

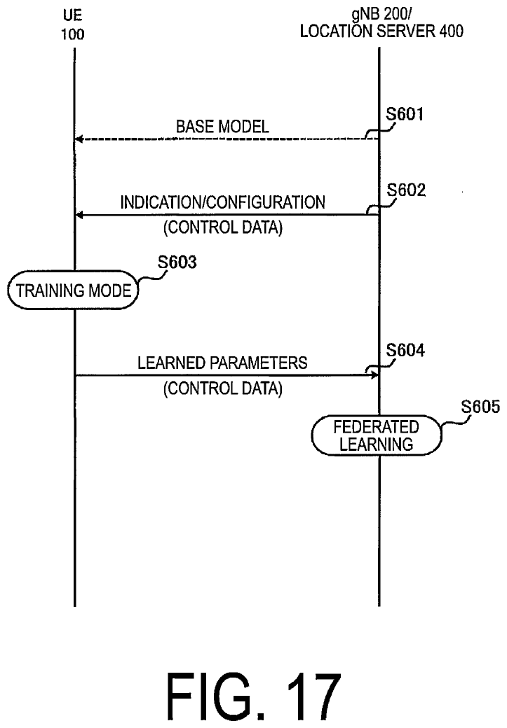

FIG. 17 is an operation flow diagram illustrating an operation example relating to the third operation scenario according to an embodiment.

In step S601, the gNB 200 may transmit a notification indicating a base model that the UE 100 trains. Here, the base model may be a model trained in the past. As described above, the gNB 200 may transmit the data type information indicating what is to be input data to the UE 100.

In step S602, the gNB 200 indicates the model training to the UE 100 and configures a report timing (trigger condition) of the learned parameter. The configured report timing may be a periodic timing. The report timing may be a timing triggered by learning proficiency satisfying a condition (that is, an event trigger).

For the periodic timing, the gNB 200 sets, for example, a timer value in the UE 100. The UE 100 starts a timer when starting learning (step S603) and reports the learned parameters to the gNB 200 (location server 400) when the timer expires (step S604). The gNB 200 may designate a radio frame or time to be reported to the ULE 100. The radio frame may be designated as an absolute value, e.g., SFN=512. The radio frame may be calculated by using a modulo operation. For example, the gNB 200 reports the learned parameters at the SFN that “SFN mod N=0” holds for the UE 100, where N is a set value (step S604).

For the event trigger, the completion condition as described above is configured for the UE 100. The UE 100 reports the learned parameters to the gNB 200 (location server 400) when the completion condition is satisfied (step S604). The UE 100 may trigger the reporting of the learned parameters, for example, when the accuracy of the model inference is better than the previously transmitted model. Here, an offset may be introduced to trigger when “current accuracy>previous accuracy+offset” holds. The UE 100 may trigger the reporting of the learned parameters, for example, when the training data is input (learned) N times or more. Such an offset and/or a value of N may be configured by the gNB 200 for the UE 100.

In step S604, when the condition of the report timing is satisfied, the UE 100 reports the learned parameters at that time to the network (gNB 200).

In step S605, the network (location server 400) integrates the learned parameters reported from a plurality of UEs 100.

### (4) Model Transfer Example

In the embodiment, a model transfer example is described.

### (4.1) First Operation Pattern Relating to Model Transfer

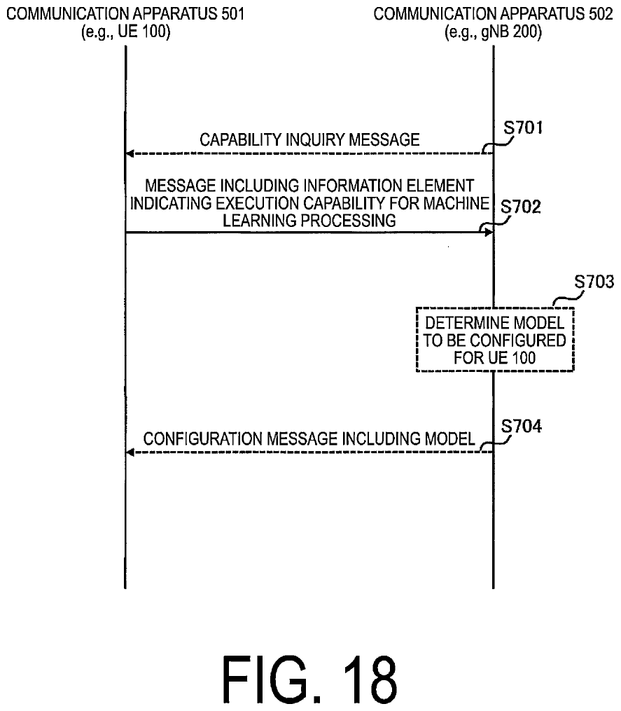

FIG. 18 is a diagram illustrating a first operation pattern relating to model transfer according to an embodiment. In the drawings referenced in the following embodiment, non-essential processing is indicated by a dashed line. In the following embodiment, it is assumed that the communication apparatus 501 is mainly the UE 100, but the communication apparatus 501 may be the gNB 200 or the AMF 300A. It is assumed that the communication apparatus 502 is mainly the gNB 200, but the communication apparatus 502 may be the UE 100 or the AMF 300A.

As illustrated in FIG. 18, in step S701, the gNB 200 transmits, to the UE 100, a capability inquiry message for requesting transmission of the message including the information element indicating the execution capability for the machine learning processing. The capability inquiry message is an example of the transmission request for requesting transmission of the message including the information element indicating the execution capability for the machine learning processing. The UE 100 receives the capability inquiry message. However, the gNB 200 may transmit the capability inquiry message when performing the machine learning processing (when determining to perform the machine learning process).

In step S702, the UE 100 transmits, to the gNB 200, the message including the information element indicating the execution capability (an execution environment for the machine learning processing, from another viewpoint) for the machine learning processing. The gNB 200 receives the message. The message may be an RRC message, for example, a “UE Capability” message defined in the RRC technical specifications, or a newly defined message (e.g., a “UE AI Capability” message or the like). The communication apparatus 502 may be the AMF 300A and the message may be a NAS message. When a new layer for performing or controlling the machine learning processing (AI/ML processing) is defined, the message may be a message of the new layer. The new layer is adequately referred to as an “AI/ML layer”.

The information element indicating the execution capability for the machine learning processing is at least one selected from group consisting of the information elements (A1) to (A3) below.

### Information Element (A1)

The information element (A1) is an information element indicating capability of the processor for performing the machine learning processing and/or an information element indicating capability of the memory for performing the machine learning processing.

The information element indicating the capability of the processor for performing the machine learning processing may be an information element indicating whether the UE 100 includes an AI processor. When the UE 100 includes the processor, the information element may include an AI processor product number (model number). The information element may be an information element indicate whether a Graphics Processing Unit (GPU) is usable by the UE 100. The information element may be an information element indicating whether the machine learning processing needs to be performed by the CPU. The information element indicating the capability of the processor for performing the machine learning processing being transmitted from the UE 100 to the gNB 200 allows the network side to determine whether a neural network model is usable as a model by the UE 100, for example. The information element indicating the capability of the processor for performing the machine learning processing may be an information element indicating a clock frequency and/or the number of parallel executables for the processor.

The information element indicating the capability of the memory for performing the machine learning processing may be an information element indicating a memory capacity of a volatile memory (e.g., a Random Access Memory (RAM)) of the memories of the UE 100. The information elements may be an information element indicating a memory capacity of a non-volatile memory (e.g., a Read Only Memory (ROM)) of the memories of the UE 100. The information element may indicate both of these. The information element indicating the capability of the memory for performing the machine learning processing may be defined for each type such as a model storage memory, an AI processor memory, or a GPU memory.

The information element (A1) may be defined as an information element for the inference processing (model inference). The information element (A1) may be defined as an information element for the learning processing (model training). Both the information element for the inference processing and the information element for the learning processing may be defined as the information element (A1).

### Information Element (A2)

The information element (A2) is an information element indicating the execution capability for the inference processing. The information element (A2) may be an information element indicating a model supported in the inference processing. The information element may be an information element indicating whether a deep neural network model is able to be supported. In this case, the information element may include at least one selected from the group consisting of information indicating the number of supportable layers (stages) of a neural network, information indicating the number of supportable neurons (which may be the number of neurons per layer), and information indicating the number of supportable synapses (which may be the number of input or output synapses per layer or per neuron).

The information element (A2) may be an information element indicating the execution time (response time) required to perform the inference processing. The information element (A2) may be an information element indicating the number of simultaneous executions of the inference processing (e.g., how many pieces of inference processing can be performed in parallel). The information element (A2) may be an information element indicating the processing capacity of the inference processing. For example, when a processing load for a certain standard model (standard task) is determined to be one point, the information element indicating the processing capacity of the inference processing may be information indicating how many points the processing capacity of the inference processing itself is.

### Information Element (A3)

The information element (A3) is an information element indicating the execution capability for the learning processing. The information element (A3) may be an information element indicating a learning algorithm supported in the learning processing. Examples of the learning algorithm indicated by the information element include supervised learning (e.g., linear regression, decision tree, logistic regression, k-nearest neighbor algorithm, and support vector machine), unsupervised learning (e.g., clustering, k-means, and principal component analysis), reinforcement learning, and deep learning. When the UE 100 supports deep learning, the information element may include at least one selected from the group consisting of information indicating the number of supportable layers (stages) of a neural network, information indicating the number of supportable neurons (which may be the number of neurons per layer), and information indicating the number of supportable synapses (which may be the number of input or output synapses per layer or per neuron).

The information element (A3) may be an information element indicating the execution time (response time) required to perform the learning processing. The information element (A3) may be an information element indicating the number of simultaneous executions of the learning processing (e.g., how many pieces of learning processing can be performed in parallel). The information element (A3) may be an information element indicating the processing capacity of the learning processing. For example, when a processing load for a certain standard model (standard task) is determined to be one point, the information element indicating the processing capacity of the learning processing may be information indicating how many points the processing capacity of the learning processing itself is. Note that since the processing load of the learning processing is generally higher than that of the inference processing, the number of simultaneous executions may be information such as the number of simultaneous executions with the inference processing (e.g., two pieces of inference processing and one piece of learning processing).

In step S703, the gNB 200 determines a model to be configured (deployed) for the UE 100 based on the information element included in the message received in step S702. The model may be a trained model used by the UE 100 in the inference processing. The model may be an untrained model used by the UE 100 in the learning processing.

In step S704, the gNB 200 transmits a message including the model determined in step S703 to the UE 100. The UE 100 receives the message and performs the machine learning processing (learning processing and/or inference processing) using the model included in the message. A specific example of step S704 is described in the second operation pattern below.

### (4.2) Second Operation Pattern Relating to Model Transfer

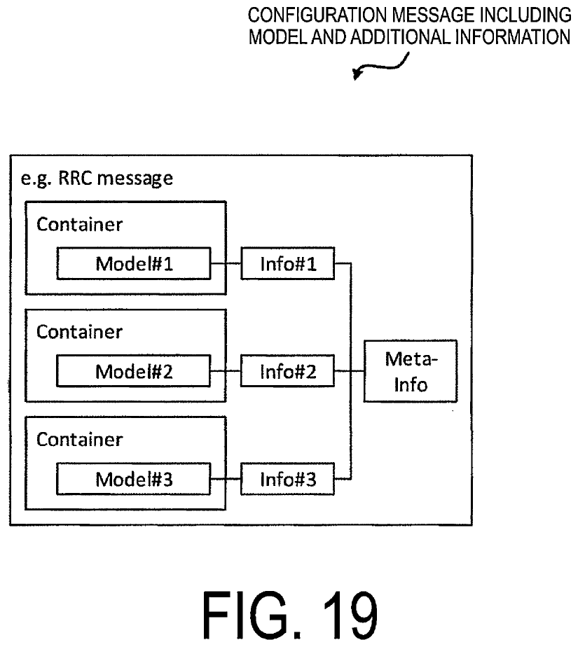

FIG. 19 is a diagram illustrating an example of a configuration message including models and additional information according to an embodiment. The configuration message may be an RRC message transmitted from the gNB 200 to the UE 100, for example, an “RRC Reconfiguration” message defined in the RRC technical specifications, or a newly defined message (such as an “A1 Deployment” message or an “A1 Reconfiguration” message). The configuration message may be a NAS message transmitted from the AMF 300A to the UE 100. When a new layer for performing or controlling the machine learning processing (AI/ML processing) is defined, the message may be a message of the new layer.

In the example of FIG. 19, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

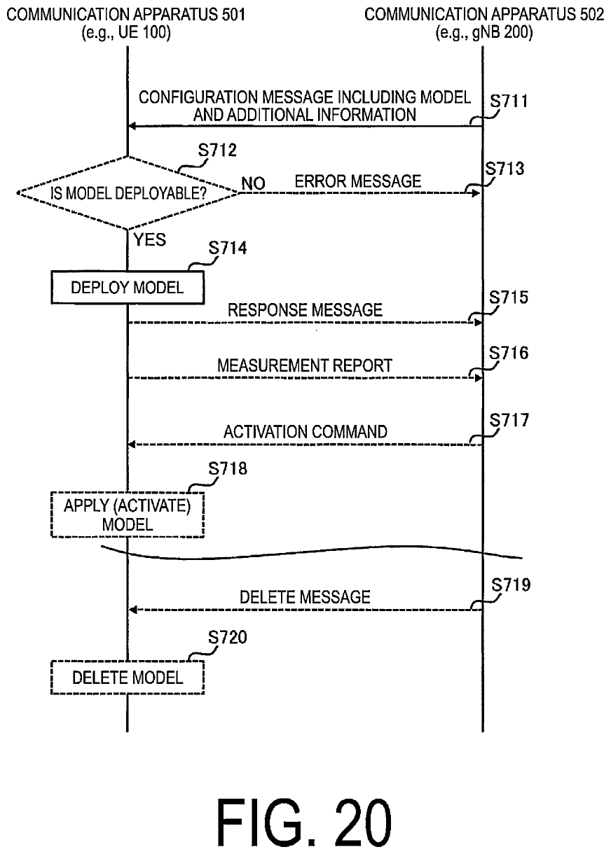

FIG. 20 is a diagram illustrating the second operation pattern relating to model transfer according to an embodiment.

In step S711, the gNB 200 transmits a configuration message including a model and additional information to the UE 100. The UE 100 receives the configuration message. The configuration message includes at least one selected from the group consisting of the information elements (B1) to (B6) below.

### (B1) Model

The “model” may be a trained model used by the UE 100 in the inference processing. The “model” may be an untrained model used by the UE 100 in the learning processing. In the configuration message, the “model” may be encapsulated (containerized). When the “model” is a neural network model, the “model” may be represented by the number of layers (stages), the number of neurons per layer, a synapse (weight) between the neurons, and the like. For example, a trained (or untrained) neural network model may be represented by a combination of matrices.

A plurality of “models” may be included in one configuration message. In this case, the plurality of “models” may be included in the configuration message in a list format. The plurality of “models” may be configured for the same application or may be configured for different applications. The application of the model is described in detail below.

### (B2) Model Index (Also Referred to as “Model ID”)

A “model index” is an example of the additional information (e.g., individual additional information). The “model index” is an index (index number) assigned to a model. In the activation command and the delete message described below, a model can be designated by the “model index”. When the configuration change of the model is performed, a model can be designated by the “model index” as well.

### (B3) Model Application

The “model application” is an example of the additional information (individual additional information or common additional information). The “model application” designates a function to which a model is applied. For example, examples of the functions to which the model is applied include CSI feedback, beam management (beam estimation, overhead latency reduction, beam selection accuracy improvement), positioning, modulation and demodulation, coding and decoding (CODEC), and packet compression. The contents of the model application and indexes (identifiers) thereof may be predefined in the 3GPP technical specifications, and the “model application” may be designated by the index. For example, the model application and the index (identifier) thereof are defined such that the CSI feedback is assigned with an application index #A and the beam management is assigned with an application index #B. The UE 100 deploys the model for which the “model application” is designated to the functional block corresponding to the designated application. Note that the “model application” may be an information element that designates input data and output data of a model.

### (B4) Model Execution Requirement

A “model execution requirement” is an example of the additional information (e.g., individual additional information). The “model execution requirement” is an information element indicating a performance required to apply (execute) the model (required performance), for example, a processing delay (request latency).

### (B5) Model Selection Criterion

A “model selection criterion” is an example of the additional information (individual additional information or common additional information). In response to a criterion designated by the “model selection criterion” being met, the UE 100 applies (executes) the corresponding model. The “model selection criterion” may be the migration speed of the UE 100. In this case, the “model selection criterion” may be designated by a speed range such as “low-speed migration” or “high-speed migration”. The “model selection criterion” may be designated by a threshold value of the migration speed. The “model selection criterion” may be a radio quality (e.g., RSRP/RSRQ/SINR) measured in the UE 100. In this case, the “model selection criterion” may be designated by a range of the radio quality. The “model selection criterion” may be designated by a threshold value of the radio quality. The “model selection criterion” may be a position (latitude/longitude/altitude) of the UE 100. As the “model selection criterion”, a notification (activation command described below) from a sequential network may be configured to be conformed, or an autonomous selection by the UE 100 may be designated.

### (B6) Whether to Require Learning Processing

The “whether to require learning processing” is an information element indicating whether the learning processing (or relearning) on the corresponding model is required or is able to be performed. When the learning processing is required, parameter types used for the learning processing may be further configured. For example, for the CSI feedback, the CSI-RS and the UE migration speed are configured to be used as parameters. When the learning processing is required, a method of the learning processing, for example, supervised learning, unsupervised learning, reinforcement learning, or deep learning may be further configured. Whether the learning processing is performed immediately after the model is configured may be further configured. When the learning processing is not performed immediately, learning execution may be controlled by the activation command described below. For example, for the federated learning, whether to notify the gNB 200 of a result of the learning processing of the UE 100 may be further configured. When a notification of the result of the learning processing of the UE 100 is required to be provided to the gNB 200, the UE 100, after performing the learning processing, may encapsulate and transmit the trained model or the learned parameter to the gNB 200 by using an RRC message or the like. The information element indicating “whether to require learning processing” may be an information element indicating, in addition to whether to require learning processing, whether the corresponding model is used only for the model inference.

In step S712, the UE 100 determines whether the model configured in step S711 is deployable (executable). The UE 100 may make this determination at the time of activation of the model, which is described below, and in step S713, which is described later, a message may be transmitted for a notification of an error at the time of the activation. The determination may be made during using the model (during performing the machine learning processing) instead of the time of the deployment or the activation. When the model is determined to be non-deployable (NO in step S712), that is, when an error occurs, in step S713, the UE 100 transmits an error message to the gNB 200. The error message may be an RRC message transmitted from the UE 100 to the gNB 200, for example, a “Failure Information” message defined in the RRC technical specifications, or a newly defined message (e.g., an “A1 Deployment Failure Information” message). The error message may be Uplink Control Information (UCI) defined in the physical layer or a MAC control element (CE) defined in the MAC layer. The error message may be a NAS message transmitted from the UE 100 to the AMF 300A. When a new layer (AI/ML layer) for performing the machine learning processing (AI/ML processing) is defined, the message may be a message of the new layer.

The error message includes at least one selected from the group consisting of the information elements (C1) to (C3).

### (C1) Model Index

This is a model index of the model determined to be non-deployable.

### (C2) Application Index

This is an application index of the model determined to be non-deployable.

### (C3) Error Cause

This is an information element related to a cause of an error. The “error cause” may be, for example, “unsupported model”, “processing capacity exceeded”, “error occurrence phase”, or “other errors”. Examples of the “unsupported model” include, for example, a model that the UE 100 cannot support a neural network model, and a model that the machine learning processing (AI/ML processing) of a designated function cannot be supported. Examples of the “processing capacity exceeded” include, for example, an overload (a processing load and/or a memory load exceeds a capacity), a request processing time being not able to be satisfied, and an interrupt processing or a priority processing of an application (upper layer). The “error occurrence phase” is information indicating when an error has occurred. The “error occurrence phase” may include a classification such as a time of deployment (configuration) time, a time of activation time, or a time of operation. The “error occurrence phase” may include a classification such as a time of inference processing or a time of learning processing. The “other errors” include other causes.

The UE 100 may automatically delete the corresponding model when an error occurs. The UE 100 may delete the model when confirming that an error message is received by the gNB 200, for example, when an ACK is received at the lower layer. The gNB 200, when receiving an error message from the UE 100, may recognize that the model has been deleted.

On the other hand, when the model configured in step S711 is determined to be deployable (YES in step S712), that is, when no error occurs, in step S714, the UE 100 deploys the model in accordance with the configuration. The “deployment” may mean bringing the model into an applicable state. The “deployment” may mean actually applying the model. In the former case, the model is not applied when the model is only deployed, but the model is applied when the model is activated by the activation command described below. In the latter case, once the model is deployed, the model is brought into a state of being used.

In step S715, the UE 100 transmits a response message to the gNB 200 in response to the model deployment being completed. The gNB 200 receives the response message. The UE 100 may transmit the response message when the activation of the model is completed by the activation command described below. The response message may be an RRC message transmitted from the UE 100 to the gNB 200, for example, an “RRC Reconfiguration Complete” message defined in the RRC technical specifications, or a newly defined message (e.g., an “A1 Deployment Complete” message). The response message may be a MAC CE defined in the MAC layer. The response message may be a NAS message transmitted from the UE 100 to the AMF 300A. When a new layer for performing the machine learning processing (AI/ML processing) is defined, the message may be a message of the new layer.

In step S716, the UE 100 may transmit a measurement report message to the gNB 200, the measurement report message being an RRC message including a measurement result of a radio environment. The gNB 200 receives the measurement report message.

In step S717, the gNB 200 selects a model to be activated, for example, based on the measurement report message, and transmits an activation command (selection command) for activating the selected model to the UE 100. The UE 100 receives the activation command. The activation command may be DCI, a MAC CE, an RRC message, or a message of the AI/ML layer. The activation command may include a model index indicating the selected model. The activation command may include information designating whether the UE 100 performs the inference processing or whether the UE 100 performs the learning processing.

The gNB 200 selects a model to be deactivated, for example, based on the measurement report message, and transmits a deactivation command (selection command) for deactivating the selected model to the UE 100. The UE 100 receives the deactivation command. The deactivation command may be DCI, a MAC CE, an RRC message, or a message of the AI/ML layer. The deactivation command may include a model index indicating the selected model. The UE 100, upon receiving the deactivation command, may not need to delete but may deactivate (cease to apply) the designated model.

In step S718, the UE 100 applies (activates) the designated model in response to receiving the activation command. The UE 100 performs the inference processing and/or the learning processing using the activated model from among the deployed models.

In step S719, the gNB 200 transmits a delete message to delete the model to the UE 100. The UE 100 receives the delete message. The delete message may be a MAC CE, an RRC message, a NAS message, or a message of the AI/ML layer. The delete message may include the model index of the model to be deleted. The UE 100, upon receiving the delete message, deletes the designated model.

### (4.3) Third Operation Pattern Relating to Model Transfer

In the third operation pattern, the UE 100 notifies the network of the load status of the machine learning processing (AI/ML processing). This allows the network (e.g., the gNB 200) to determine how many more models can be deployed (or activated) in the UE 100 based on the load status transmitted in the notification. The third operation pattern may not need to be premised on the first operation pattern relating to the model transfer described above. The third operation pattern may be premised on the first operation pattern.

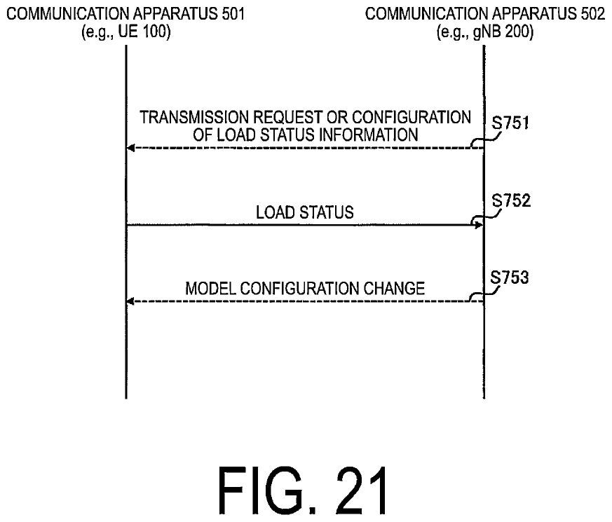

FIG. 21 is a diagram illustrating the third operation pattern relating to model transfer according to an embodiment.

In step S751, the gNB 200 transmits a message, to the UE 100, a message including a request for providing information on the AI/ML processing load status or a configuration of AI/ML processing load status reporting. The UE 100 receives the message. The message may be a MAC CE, an RRC message, a NAS message, or a message of the AI/ML layer. The configuration of AI/ML processing load status reporting may include information for configuring a report trigger (transmission trigger), for example, “Periodic” or “Event triggered”. “Periodic” configures a reporting period, and the UE 100 performs reporting in the period. “Event triggered” configures a threshold value to be compared with a value (processing load value and/or memory load value) indicating the AI/ML processing load status in the UE 100, and the UE 100 performs reporting in response to the value satisfying a condition of the threshold value. Here, the threshold value may be configured for each model. For example, in the message, the model index and the threshold value may be associated with each other.

In step S752, the UE 100 transmits a message (report message) including the AI/ML processing load status to the gNB 200. The message may be an RRC message, for example, a “UE Assistance Information” message or “Measurement Report” message. The message may be a newly defined message (e.g., an “A1 Assistance Information” message). The message may be a NAS message. The message may be a message of the AI/ML layer.

The message includes a “processing load status” and/or a “memory load status”. The “processing load status” may indicate what percentage of processing capability (capability of the processor) is already used or what remaining percentage is usable. The “processing load status” may indicate, with the load expressed in points as described above, how many points are already used and how many remaining points are usable. The UE 100 may indicate the “processing load status” for each model. For example, the UE 100 may include at least one set of “model index” and “processing load status” in the message. The “memory load status” may indicate a memory capacity, a memory usage amount, or a memory remaining amount. The UE 100 may indicate the “memory load status” for each type such as a model storage memory, an AI processor memory, and a GPU memory.

In step S752, when the UE 100 wants to stop using a particular model, for example, because of a high processing load or inefficiency, the UE 100 may include in the message information (model index) indicating a model of which configuration deletion or deactivation of model is wanted. When the processing load of the UE 100 becomes unsafe, the UE 100 may transmit the message including alert information to the gNB 200.

In step S753, the gNB 200 determines configuration change of the model or the like based on the message received from the UE 100 in step S752, and transmits a message for model configuration change to the UE 100. The message may be a MAC CE, an RRC message, a NAS message, or a message of the AI/ML layer. The gNB 200 may transmit the activation command or deactivation command described above to the UE 100.

### (5) Example of Model Management

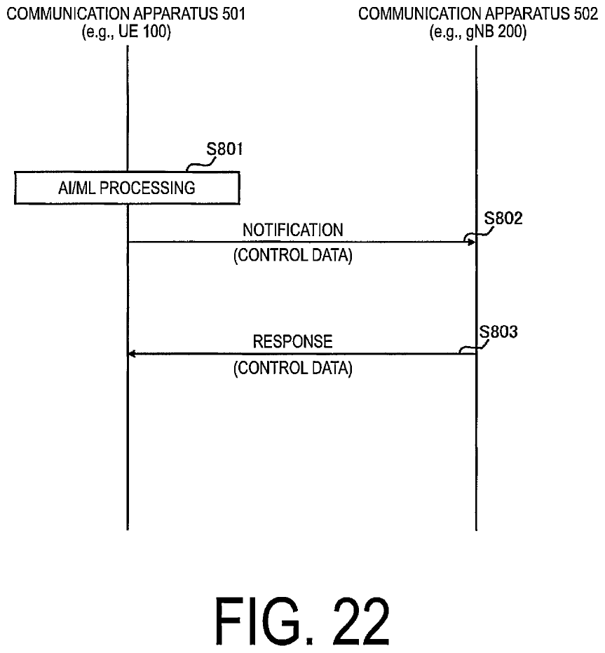

In the embodiment, an example of model management is described. FIG. 22 is a diagram illustrating an example of the model management according to the embodiment.

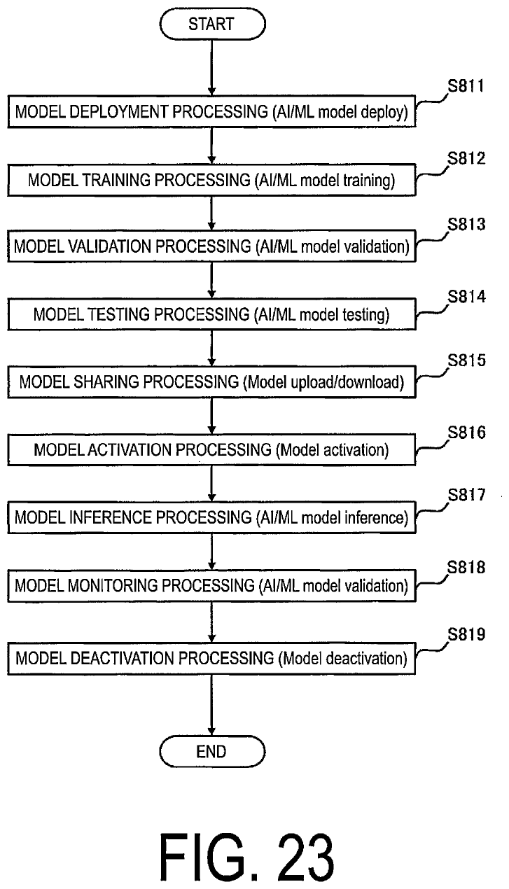

In step S801, the communication apparatus 501 performs AI/ML processing (machine learning processing). The machine learning processing is one of the steps illustrated in FIG. 23 to be described later.

In step S802, the communication apparatus 501 transmits a notification related to the machine learning processing to the communication apparatus 502 as control data. The communication apparatus 502 receives the notification.

In step S802, the communication apparatus 501 transmits a notification indicating at least one selected from the group consisting of including an untrained model, including a model in training, and including a trained model on which testing has been completed to the communication apparatus 502, for example.

In step S803, the communication apparatus 502 transmits a response corresponding to the notification of step S802 to the communication apparatus 501 as control data. The communication apparatus 501 receives the response.

The notification of step S802 may be a notification indicating that the communication apparatus 501 includes the untrained model. In this case, in step S803, a data set and/or a configuration parameter to be used for the model training may be included.

The notification of step S802 may be a notification indicating that the communication apparatus 501 includes the model in training. In this case, the response of step S803 may include a data set to continue the model training.

The notification of step S802 may be a notification indicating that the communication apparatus 501 includes the trained model on which testing has been completed. The response of step S803 may include information to start use of the trained model on which testing has been completed.

Each of the notification of step S802 and the response of step S803 may include an index of the corresponding model and/or identification information for identifying a type or an application (for example, for CSI feedback, for beam management, for positioning, or the like) of the corresponding model. These pieces of information are hereinafter also referred to as “model application information and the like”.

FIG. 23 is a diagram illustrating details of model management, specifically, step S801 of FIG. 22, according to an embodiment.

In step S811, the communication apparatus 501 performs model deployment processing. Here, the communication apparatus 501 notifies the communication apparatus 502 that the communication apparatus 501 includes an untrained model, that is, includes a model that needs to be trained. For example, the untrained model may be pre-installed when the communication apparatus 501 is shipped. The untrained model may be acquired by the communication apparatus 501 from the communication apparatus 502. When the model training has not been completed, for example, certain quality has not been satisfied, the communication apparatus 501 may notify the communication apparatus 502 that the communication apparatus 501 includes the untrained model. For example, one example of a case is that, even if the model training has been completed once, quality of the model can no longer be secured in monitoring due to movement to another environment (for example, from the indoors to the outdoors). The communication apparatus 502 may provide a training data set to the communication apparatus 501, based on the notification. The communication apparatus 502 may perform an additional configuration for the communication apparatus 501. The communication apparatus 502 may perform exclusion of application, for example, discarding, deconfiguration (deconfig.), or deactivation, of the model.

In step S812, the communication apparatus 501 performs model training processing. The communication apparatus 501 notifies the communication apparatus 502 that the communication apparatus 501 is in the process of the model training. The notification may include the model application information and the like, in a manner the same as and/or similar to the above. The communication apparatus 502 continues to provide the training data set to the communication apparatus 501, based on the notification. Note that, when the communication apparatus 502 receives a notification indicating “prior to learning” or “in the process of learning”, the communication apparatus 502 may recognize that the communication apparatus 501 applies a known technique with no model application.

In step S813, the communication apparatus 501 performs model validation processing. The model validation processing is sub-processing of the model training processing. The model validation processing is processing of evaluating quality of the AI/MIL model using a data set different from the data set used for the model training and thereby selecting (adjusting) a model parameter. The communication apparatus 501 may notify the communication apparatus 502 that the communication apparatus 501 is in the process of the model training or model validation has been completed.

In step S814, the communication apparatus 501 performs model testing processing. The model testing processing is sub-processing of the model training processing. In the model testing processing, a performance of a final AI/ML model is evaluated using a data set different from the data sets used for the model training and the model validation. Unlike the model validation, the model is not adjusted in the model testing. The communication apparatus 501 notifies the communication apparatus 502 that the communication apparatus 501 includes a tested model (that is, that can secure certain quality). The notification may include the model application information and the like, in a manner the same as and/or similar to the above. The communication apparatus 502 performs processing to start use of the model, for example, configuration or activation of the model, based on the notification. The communication apparatus 502 may determine to provide an inference data set, and perform configuration necessary for the communication apparatus 501.

In step S815, the communication apparatus 501 performs model sharing processing. For example, the communication apparatus 501 transmits (uploads) the trained model to the communication apparatus 502.

In step S816, the communication apparatus 501 performs model activation processing. The model activation processing is processing for activating (enabling) the model for a specific function. The communication apparatus 501 may notify the communication apparatus 502 that the communication apparatus 501 has activated the model. The notification may include the model application information and the like, in a manner the same as and/or similar to the above.

In step S817, the communication apparatus 501 performs model inference processing. The model inference processing is processing of generating a set of outputs based on a set of inputs, using the trained model. The communication apparatus 501 may notify the communication apparatus 502 that the communication apparatus 501 has performed the model inference. The notification may include the model application information and the like, in a manner the same as and/or similar to the above.

In step S818, the communication apparatus 501 performs model monitoring processing. The model monitoring processing is processing of monitoring inference a performance of the AI/ML model. The communication apparatus 501 may transmit a notification related to the model monitoring processing to the communication apparatus 502. The notification may include the model application information and the like, in a manner the same as and/or similar to the above. A specific example of the notification will be described later.

In step S819, the communication apparatus 501 performs model deactivation processing. The model deactivation processing is processing of deactivating (disabling) the model for a specific function. The communication apparatus 501 may notify the communication apparatus 502 that the communication apparatus 501 has deactivated the model. The notification may include the model application information and the like, in a manner the same as and/or similar to the above. The model deactivation processing may be processing of deactivating the currently active model and activating another model. The processing is also referred to as model switching.

### (6) AI/ML Control in Consideration of Area Communication Environment

In the embodiment, AI/ML control in consideration of an area communication environment is described.

The AI/ML model used for the inference processing (model inference) includes
1) a “UE side model” entirely for which the UE 100 performs the inference processing,
2) a “network side model” entirely for which the network 5 performs the inference processing, and
3) a “two-sided model” for which the UE 100 and the network 5 cooperatively perform the inference processing.

Here, each of the “UE side model” and the “network side model” is also referred to as a “one-sided model”. In the “two-sided model”, the first part of the inference processing may be performed by the UE 100, and then the remaining part of the inference processing may be performed by the gNB 200.

When the AI/ML model used for the inference processing is the UE side model, the network 5 (gNB 200) is assumed to not grasp attributes (for example, applications and/or performances) of the model. Therefore, it is difficult for the network 5 (gNB 200) to control the model, to be specific, to control the AI/ML processing using the model.

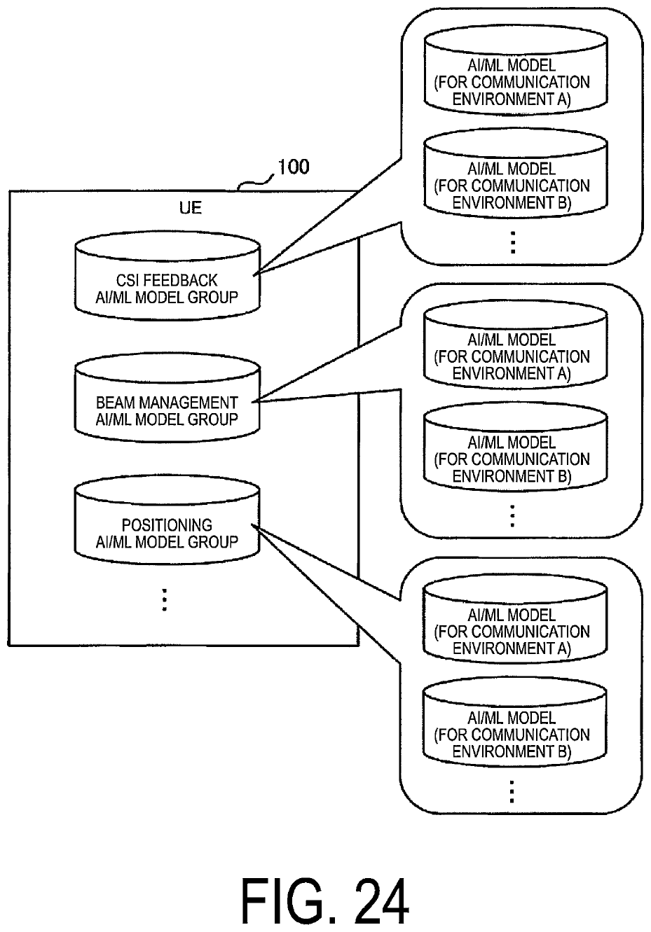

FIG. 24 is a diagram illustrating an example of the UE side model included in the UE 100. In the illustrated example, the UE 100 includes model groups different for respective applications (CSI feedback, beam management, positioning). Each model group includes a plurality of AI/ML models optimized for each communication environment. Under such a premise, the UE 100 needs to be able to appropriately select the AI/ML model used for the inference processing (and the learning process) in accordance with the current communication environment.

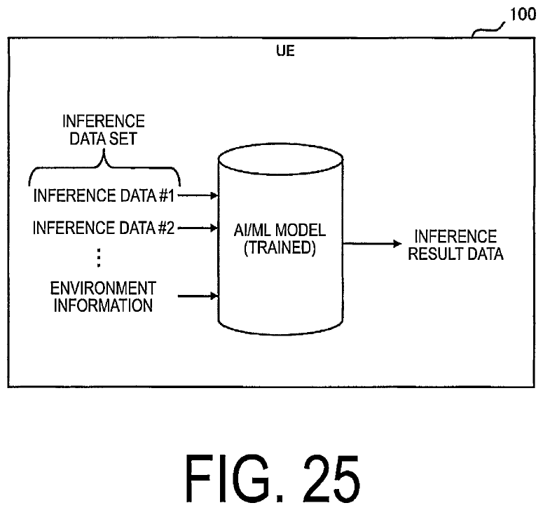

FIG. 25 is a diagram illustrating another example of the UE side model included in the UE 100. In the illustrated example, the AI/ML model uses environment information related to the current communication environment as one of the inference data sets (input data). For example, the UE 100 includes one AI/ML model that is applied to all communication environments for a certain application, and uses the environment information as additional information for accurate inference. The UE 100 inputs the environment information to the AI/ML model and acquires the inference result data outputted by the AI/ML model. Note that before performing such inference processing, the UE 100 may perform the learning processing using the environment information as one of the training data sets (input data).

### (6.1) First Operation Pattern in Consideration of Area Communication Environment

Under the premise illustrated in FIGS. 24 and 25, the network 5 provides the UE 100 with the environment information used by the UE 100 to perform the AI/ML processing among the learning processing and/or the inference processing using the AI/ML model.

That is, the UE 100 receives, from the network 5, the environment information indicating a communication environment (also referred to as an “area communication environment”) of a coverage area corresponding to the location of the UE 100. The coverage area corresponding to the location of the UE 100 may be a cell in which the UE 100 exists, a tracking area in which the UE 100 exists, or a registration area in which the UE 100 exists. However, the coverage area corresponding to the location of the UE 100 may be a peripheral area of the UE 100, which may be an area unit smaller than a cell. For example, the coverage area corresponding to the location of the UE 100 may be a beam. The beam is identified by a synchronization signal/PBCH block (SSB) index, for example. The UE 100 performs the AI/ML processing among the learning processing and/or the inference processing using the AI/ML model based on the environment information received from the network 5. As a result, the UE 100 can perform the AI/ML processing in consideration of the environment information. Note that the environment information provided by the network 5 may be information for assisting the AI/ML processing in the UE 100, which may be referred to as assist information.

The environment information is a parameter indicative of a geographical characteristic of the coverage area, which is at least one environmental parameter affecting wireless propagation. For example, the environment information may include at least one selected from the group consisting of information indicating a density of constructions in the coverage area, information indicating a population density in the coverage area, information indicating whether the coverage area is indoors, information indicating a size of a cell included in the coverage area, and information indicating a height of an antenna in the cell.

Under the premise illustrated in FIG. 24, the UE 100 that has received the environment information from the network 5 may select an AI/ML model to be used in the AI/ML processing from among a plurality of AI/ML models included in the UE 100 in accordance with the environment information. Accordingly, the UE 100 can select an appropriate AI/ML model in consideration of the environment information and perform the AI/ML processing using the selected AI/ML model.

Under the premise as illustrated in FIG. 25, the UE 100 that has received the environment information from the network 5 may perform the AI/ML processing using the environment information as input for the AI/ML model. Accordingly, the UE 100 can accurately perform the inference processing using, for example, the AI/ML model.

The UE 100 may receive, from the network 5, information permitting the UE 100 to use the AI/ML model. When the UE is permitted to use the AI/ML model, the UE 100 may perform the AI/ML processing using the AI/ML model. Accordingly, the UE 100 can perform the AI/ML processing under the management of the network 5.

The UE 100 may transmit, to the network 5, request information to request the environment information to be transmitted. Accordingly, the UE 100 can acquire the environment information from the network 5 in an appropriate situation and at an appropriate timing.

The UE 100 may receive, from the network 5, information permitting the UE 100 to transmit the request information. The UE 100 may transmit the request information to the network 5 based on the request information being permitted to be transmitted. Accordingly, the UE 100 can acquire the environment information under the management of the network 5.

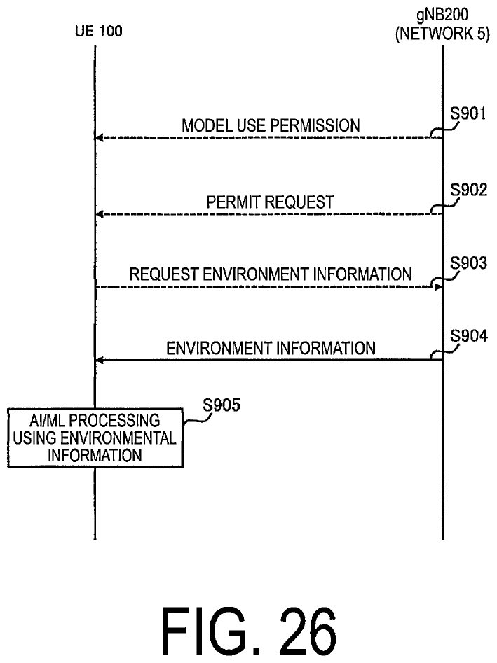

FIG. 26 is a diagram illustrating an operation example of the first operation pattern in consideration of the area communication environment according to the embodiment. In this operational example, the UE 100 may include a plurality of UE implementation dependent/vendor dependent AI/ML models. Such an AI/ML model is also referred to as a proprietary model. In this operation example, assume that a network entity providing auxiliary information is the gNB 200, but the network entity providing the auxiliary information may be another network entity, for example, the AMF 300, and the gNB 200 in FIG. 26 may be read as the AMF 300.

In step S901, the gNB 200 may give the UE 100 usage permission of the model inference (and/or training). For example, the gNB 200 transmits a message including at least one piece of the following information to the UE 100.
Information indicating whether the one-sided model may be used.
Information indicating whether the proprietary model may be used.
   Here, the gNB 200 may individually give permission/non-permission for respective applications (CSI feedback, beam management, positioning). The message of step S901 may be a system information block (SIB) transmitted in broadcast. The message may be dedicated signaling transmitted in unicast (for example, an RRC Reconfiguration message). The UE 100 determines whether to use the AI/ML model included in the UE 100 itself based on the received message.

In step S902, the gNB 200 may permit the UE 100 to request the environment information related to the model inference (and/or training). For example, the gNB 200 transmits a message including at least one piece of the following information to the UE 100.
Information indicating whether the UE 100 may request the environment information.
Information indicating what items of the environment information can be provided by the gNB 200 (item list).
   Here, the gNB 200 may individually give permission/non-permission for respective applications (CSI feedback, beam management, positioning). Note that the items of the environment information are described below. The message of step S902 may be an SIB transmitted in broadcast. The message may be dedicated signaling (for example, an RRC Reconfiguration message). The UE 100 determines whether UE 100 may request the environment information based on the received message.

In step S903, the UE 100 may transmit a request for the environment information to the gNB 200. For example, the UE 100 transmits a message including at least one piece of the following information to the gNB 200.
Information indicating the applications (CSI feedback, beam management or positioning).
Information indicating whether the environment information is used for inference or for learning.
Information indicating whether the environment information is used for the one-sided model (UE side model) or the two-sided model.
Information indicating whether the environment information is used for the proprietary model or for the model provided (managed) by the network 5.
Information specifying the items of the environment information to be needed.
Information related to the frequency of providing the environment information: It may be information indicating whether one shot provision or periodic provision is desired. When the periodic provision is desired, the provision frequency (time interval, number of times, etc.) may be further transmitted as a notification.
   The message of step S903 may be, for example, an RRC Setup Request message, an RRC Resume Request message, or a UE Assistance Information message. The gNB 200 receives the message. Alternatively, the UE 100 may transmit the request for the environment information by transmitting a random access preamble to the gNB 200 using a physical random access channel (PRACH) resource prepared for the request for environment information. The UE 100 may be permitted to transmit the request in step S903 only when at least one of the following conditions is met.
The model inference (and/or training) is permitted in step S901.
The request for the environment information is permitted in step S902.

In step S904, the gNB 200 provides the UE 100 with the environment information of a cell (serving cell) in which the UE 100 exists. For example, the gNB 200 transmits a message including at least one piece of the following information (items) to the gNB 200.
Information on the arrangement of constructions such as buildings: Urban, Suburban, Rural.
Information on the arrangement of reflectors: Indoor, Outdoor.
Cell radius, cell type (femto, pico, micro, macro, etc.), (class of) transmit power.
Antenna height, LOS (Line of Sight)/NLOS (Non Line of Sight).
   These pieces of information may be information of a neighboring cell in addition to the information of the serving cell. The message of step S904 may be, for example, an SIB or dedicated signaling (for example, an RRC Reconfiguration message).

In step S905, the UE 100 performs at least one of the following processes according to the environment information received in step S904.
The UE 100 selects an appropriate AI/ML model on the basis of the environment information, to be more specific, an AI/ML model matching the communication environment indicated by the environment information, from among a plurality of AI/ML models included in the UE 100. For example, the UE 100 in the communication environment of urban and outdoor selects an AI/ML model for Urban/Outdoor.
The UE 100 inputs the environment information as inference data (and/or training data) to the AI/ML model. For example, the UE 100 inputs the environment information as the inference data to the trained model for CSI feedback in addition to the radio measurement data.

When the AI/ML processing is normally completed, the UE 100 may notify the gNB 200 that the processing is normally completed. For example, when the selection of the appropriate model is completed, the UE 100 may notify the gNB 200 that the selection of the appropriate model is completed. On the other hand, when the AI/ML processing is abnormally terminated (or not normally completed), the UE 100 may transmit a notification to the gNB 200. For example, the UE 100 may notify the gNB 200 that an appropriate model could not be selected.

In this operation example, new information not defined by the existing 3GPP technical specifications is introduced as the environment information. However, information defined by the existing 3GPP technical specifications may be used as at least a part of the environment information. For example, at least one piece of the following information provided by the gNB 200 in the current specifications may be used as the environment information.
SIB9: Time Info (time information).
SIB19: Reference Location (location information for non-terrestrial network (NTN)).
SIB21: MBS FSAI (Multicast/Broadcast Service (MBS) area for MBS).

### (6.2) Second Operation Pattern in Consideration of Area Communication Environment

The above-described first operation pattern is on the assumption that the gNB 200 assists the UE 100 implementation dependent AI/ML processing using the environment information. However, from the viewpoint of an operator and/or a vendor of the network 5, it is not preferable to publish information on the network 5 (provide the information to the UE 100) in terms of security or the like. Therefore, in the second operation pattern, the UE 100 notifies the network 5 of an AI/ML model included in the UE 100, and uses the model in response to an indication from the gNB 200.

That is, the UE 100 transmits the model information indicating the attributes of the AI/ML model included in the UE 100 to the network 5. After that, the UE 100 receives information indicating whether the UE 100 is capable of using the AI/ML model, from the network 5. Accordingly, the network 5 can cause the UE 100 to use an appropriate AI/ML model in consideration of, for example, a communication environment at the location of the UE 100 (for example, a communication environment of a cell in which the UE 100 exists).

The model information transmitted from the UE 100 to the network 5 may include at least one selected from the group consisting of information indicating a type of the AI/ML model, information indicating dependency of the AI/ML model on the network 5, information indicating whether to learn the AI/ML model, information indicating whether to use the environment information from the network 5 for the learning processing and/or the inference processing using the AI/ML model, information indicating an application of the AI/ML model, and information indicating an application environment of the AI/ML model.

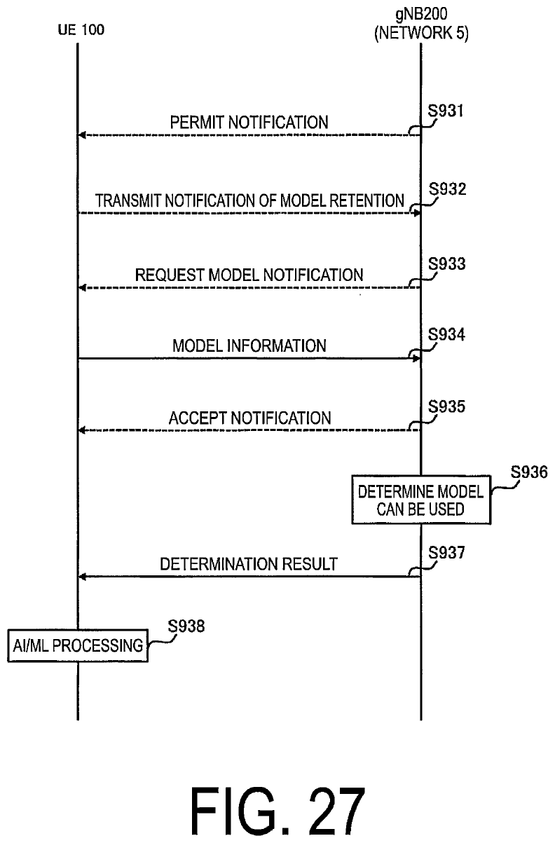

FIG. 27 is a diagram illustrating an operation example of the second pattern in consideration of the area communication environment according to the embodiment. In this operational example, the UE 100 may include a plurality of UE implementation dependent/vendor dependent AI/IL models. Such an AI/ML model is also referred to as a proprietary model. In this operation example, assume that a notification destination of the model information (from another viewpoint, a registration destination) is the gNB 200, but the notification destination of the model information may be another network entity, for example, the AMF 300, and the gNB 200 in FIG. 27 may be read as the AMF 300.

In step S931, the gNB 200 may broadcast information, for example, in an SIB to the UE 100, the information indicating that a model notification (model registration) from the UE 100 is possible or that the gNB 200 supports an AI/ML function. The information may be transmitted by a UE-specific notification (configuration) through dedicated signaling (for example, an RRC Reconfiguration message).

In step S932, the UE 100 may transmit, to the gNB 200, information (e.g., 1-bit flag information) indicating that the UE 100 has an AI/ML model of which notification (registration) the UE 100 can make. For example, the UE 100 may transmit the information in message (Msg) 5 of the random access procedure. The UE 100 may transmit the information in a UE Assistance Information message.

In step S933, the gNB 200 may transmit request information, to the UE 100, to request (or permit) the UE 100 to notify the gNB 200 of the model information. The gNB 200 may broadcast the request information in an SIB. The gNB 200 may transmit the request information through dedicated signaling.

In step S934, the UE 100 transmits the model information indicating the attributes of the AI/ML model included in the UE 100 to the gNB 200. For example, the UE 100 transmits a message including at least one piece of the following information to the gNB 200.
Information indicating whether the AI/ML model is a one-sided model or a two-sided model.
Information indicating whether the AI/ML model is a proprietary model (UE implementation dependent/vendor dependent AI/ML model), an open format model (AI/ML model based on a format standardized and/or published outside the 3GPP), or a model provided from a 3GPP network (network implementation dependent/network vendor dependent AI/ML model transferred from the network 5 to the UE 100).
Information indicating the dependency (collaboration level) of the AI/ML model on the network 5. For example, the collaboration levels include a level X (no collaboration), a level Y (signaling-based collaboration without model transfer from the network 5), and a level Z (signaling-based collaboration with model transfer from the network 5).
Information indicating whether the AI/ML model is a trained model. The information may be information indicating whether learning is required or whether learning is possible.
Information indicating whether the AI/ML model requires the environment information.
Information indicating the applications (CSI feedback, beam management or positioning) of the AI/ML model.
Information related to a communication environment to which the AI/ML model is applied.
Model ID of the AI/ML model. This is an ID assigned to the AI/ML model on the UE 100 side. The ID may be a temporary ID that can be updated on the gNB 200 side. To be more specific, the gNB 200 may have authority to issue a regular model ID, and the temporary ID may be replaced with the regular model ID. Alternatively, the ID may be an ID that is not updated on the gNB 200 side. Note that the model ID may be a name of the AI/ML model.
   The UE 100 may notify the gNB 200 of such model information for each AI/ML model. For example, the UE 100 may transmit, to the gNB 200, a message including the model information in a list format of each of a plurality of AI/ML models included in the UE 100. In this case, the model IDs may be implicitly assigned in the order of entries in the list, for example, 0, 1, 2, and the like. The message of step S934 may be, for example, a UE Capability message, a UE Assistance Information message, or a new message (for example, an AI/ML Assistance Information message). The gNB 200 receives the message. The gNB 200 may assign a new model ID to each model the gNB 200 is notified of. The gNB 200 may use the model ID the gNB 200 is notified of without change.

In step S935, the gNB 200 may transmit a notification indicating that the gNB 200 has received the model notification (model registration) to the UE 100. When the gNB 200 assigns a new model ID to the model, the gNB 200 may transmit information associating the temporary ID of the model with the new ID to the UE 100. Alternatively, the gNB 200 may notify the UE 100 that the gNB 200 has not accepted the model registration (model registration failure).

In step S936, the gNB 200 selects a model to be used by the UE 100 from among the models the gNB 200 has been notified of by the UE 100 according to the current communication environment (i.e., determines whether to use each model). For example, when the communication environment of the coverage of the gNB 200 (to be specific, the serving of the UE 100) is urban, the gNB 200 determines that an urban model is to be used by the UE 100.

In step S937, the gNB 200 transmits information indicating a determination result of step S936 to the UE 100. For example, the gNB 200 transmits a set of a model ID and a model deployment indication or a model activation indication to the UE 100 for a model to be used by the UE 100. The gNB 200 may transmit a set of a model ID and a model de-deployment/release indication or a model deactivation indication to the UE 100 for a model not to be used by the UE 100. The message of step S937 may be dedicated signaling, for example, an RRC Reconfiguration message or a MAC CE. The UE 100 receives the message.

In step S938, the UE 100 executes the operation of the model according to the indication of step S937. For example, a UE 100 may deploy or activate a model for which model deployment or model activation has been indicated. The UE 100 may de-deploy or deactivate a model for which model de-deployment/release or model deactivation has been indicated.

Note that when the UE 100 is handed over from the cell of gNB 200 to a cell of another gNB (target gNB), the gNB 200 may notify the target gNB of the model information acquired in step S934. For example, the gNB 200 may transmit a Handover Request message including the model information as part of UE context information to the target gNB.

### (7) Transmission Path Used for Model Transfer

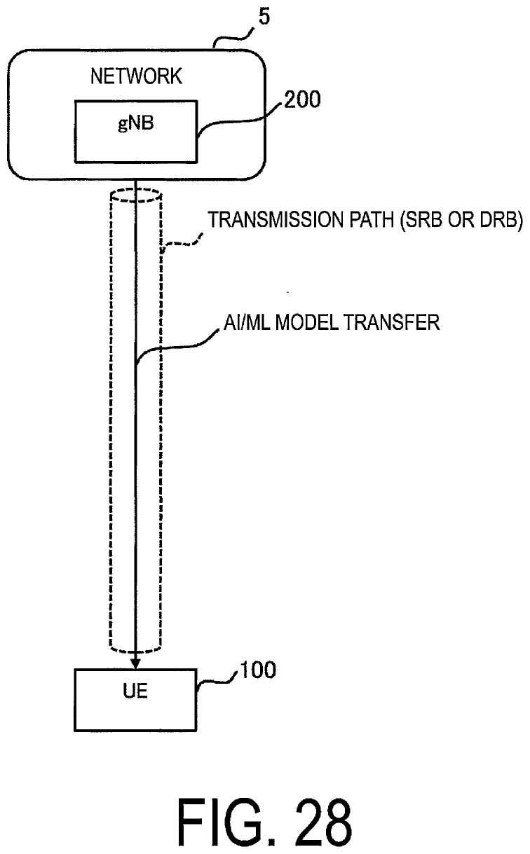

With reference to FIG. 28, a transmission path used for the model transfer is described according to the embodiment.

When the AI/ML model is provided by the network 5 to the UE 100 (model transfer), candidates for a transmission path used for the model transfer include a signaling radio bearer (SRB) and a data radio bearer (DRB). Specifically, the SRB is used when the model transfer is performed in the control plane, and the DRB is used when the model transfer is performed in the user plane. A plurality of types of SRBs are defined in technical specifications. The DRB is appropriately configured for the UE 100 from the network 5. When the SRB is used as the transmission path used for the model transfer, a model having a large size is difficult to transfer. Therefore, the SRB is assumed to be used as the transmission path used for the model transfer for a model having a large size.

Under the premise that there are such various transmission path candidates, the UE 100 is desired to be able to grasp which transmission path is used for the model transfer. Therefore, assume that the network 5 configures the transmission path used for the model transfer for the UE 100. That is, the UE 100 receives, from the network 5, configuration information for configuring a transmission path used for transfer of the AI/ML model from the network 5 to the UE 100. The UE 100 receives the AI/ML model from the network 5 via the transmission path. Thus, the UE 100 can appropriately receive the AI/ML model from the network 5.

The configuration information for configuring the transmission path may include information indicating which of the SRB and the DRB is configured as the transmission path. The configuration information for configuring the transmission path may include information for identifying the SRB to be configured as the transmission path. The configuration information for configuring the transmission path may include information for identifying the DRB to be configured as the transmission path and/or a transmission source address in the transmission path.

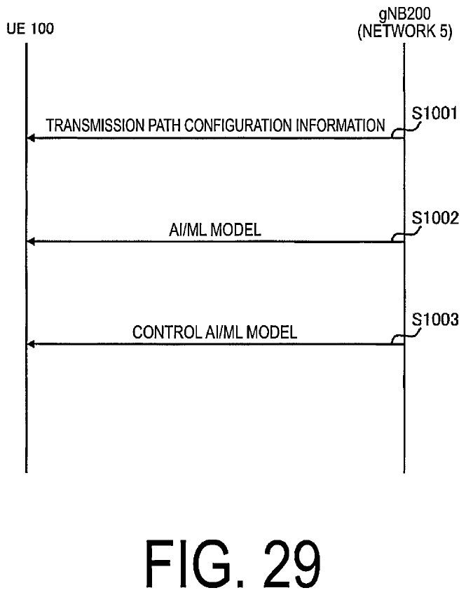

FIG. 29 is a diagram illustrating an operation example for the configuration of the transmission path used for the model transfer according to the embodiment.

In step S1001, the gNB 200 transmits, to the UE 100, the configuration information for configuring the transmission path for transmitting the model for the UE 100 through dedicated signaling (for example, an RRC Reconfiguration message). The UE 100 may receive the configuration information and establish the transmission path.

The configuration information may include information indicating whether to use the SRB or the DRB as the transmission path.

When the SRB is used as the transmission path, the configuration information may include information for identifying a type of the SRB. The types of the SRB include SRB1 to SRB4. The SRB1 is an SRB mainly used for an SIB. The SRB2 is an SRB mainly used for a dedicated RRC message. The SRB2 is an SRB mainly used for a NAS message. The SRB3 is an SRB used for signaling from a secondary node during dual connectivity. The SRB4 is an SRB used for an application-based message, for example, a QoE report.

When the DRB is used as the transmission path, the configuration information may include a DRB ID and/or a source IP address. For example, the gNB 200 may include information indicative of model transmission in a DRB configuration (including a configuration of a DRB ID) for the UE 100. The source IP addresses may be the IP addresses of the server or gNB 200 from which the model is transmitted. The configuration information may include information indicating whether to manage and control the model in the control plane. For example, the gNB 200 may notify the UE 100 of the model ID in the control plane (SRB) and transfer the model to the UE 100 in the user plane (DRB) so that the model is associated with the model ID on the UE 100 side. Note that the UE 100 may notify the gNB 200 of the IP addresses of the user plane of the UE 100. The IP address may be a destination IP address as viewed from the server.

In step S1002, the gNB 200 transfers the model to the UE 100 by using the transmission path configured in step S1001. The UE 100 receives and stores the model. When the model is transmitted in the user plane (DRB), the gNB 200 may include the identification information in an SDAP header or a PDCP header of a packet containing the model. The identification information includes information indicating whether to manage the model in the control plane and/or the model ID when the model is managed by the control plane. The UE 100 acquires the identification information and associates the model with the control plane (RRC).

In step S1003, the gNB 200 specifies the model ID to control deployment, activation, deactivation, etc. of the model in the control plane (RRC message). For example, when the model is transmitted in the user plane (DRB), the gNB 200 may notify the UE 100 of metadata (model header, additional information) associated with the model ID in an RRC message. The UE 100 may associate the model received in the user plane with the metadata received in the control plane based on the model ID.

### (8) Other Embodiments

The above-described embodiment has mainly described the communication between the UE 100 and the gNB 200, but the operations according to the above-described embodiment may be applied to communication between the gNB 200 and the AMF 300A (i.e., communication between the base station and the core network). The above-described signaling may be transmitted from the gNB 200 to the AMF 300A over the NG interface. The above-described signaling may be transmitted from the AMF 300A to the gNB 200 over the NG interface. The AMF 300A and the gNB 200 may exchange a request to perform the federated learning and/or a training result of the federated learning with each other. The above-described operation scenarios operations may be applied to communication between the gNB 200 and another gNB 200 (i.e., inter-base station communication). The above-described signaling may be transmitted from the gNB 200 to the other gNB 200 over the Xn interface. The gNB 200 and the other gNB 200 may exchange a request to perform the federated learning and/or a training result of the federated learning with each other. The above-described operations may be applied to communication between the ULE 100 and another UE 100 (i.e., inter-user equipment communication). The above-described signaling may be transmitted from the UE 100 to the other UE 100 over the sidelink. The UE 100 and the other UE 100 may exchange a request to perform the federated learning and/or a training result of the federated learning with each other.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (gNB) has been described. However, the base station may be an LTE base station (an eNB). The base station may be a relay node such as an Integrated Access and Backhaul (IAB) node. The base station may be a distributed unit (DU) of the IAB node. The user equipment (terminal apparatus) may be a relay node such as an IAB node or a Mobile Termination (MT) of the IAB node.

The term “network node” mainly means a base station, but may also mean a core network apparatus or a part (CU, DU, or RU) of the base station.

A program causing a computer to execute each piece of the processing performed by the communication apparatus (e.g., UE 100 or gNB 200) may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for performing each piece of processing performed by the communication apparatus may be integrated, and at least part of the communication apparatus may be configured as a semiconductor integrated circuit (chipset, System on a chip (SoC)).

As used in this disclosure, the terms “based on” and “depending on” do not mean “based only on” or “depending only on”, unless otherwise specified. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (9) Supplementary Notes

Features relating to the embodiments described above are described below as supplements.

### Supplementary Note 1

A communication method for applying an artificial intelligence or machine learning (AI/ML) technology to wireless communication between a user equipment and a network in a mobile communication system, the method including:
receiving, by a user equipment, environment information from a network, the environment information indicating an communication environment of a coverage area corresponding to a location of the user equipment; and
performing, by the user equipment, AI/IL processing among learning processing and/or inference processing using an AI/ML model, based on the environment information.

### Supplementary Note 2

The communication method according to supplementary note 1, wherein
the environment information includes at least one selected from the group consisting of information indicating a density of constructions in the coverage area, information indicating a population density in the coverage area, information indicating whether the coverage area is indoors, information indicating a size of a cell included in the coverage area, and information indicating a height of an antenna in the cell.

### Supplementary Note 3

The communication method according to supplementary note 1 or 2, wherein
the performing of the AI/ML processing includes selecting the AI/ML model to be used for the AI/ML processing from among a plurality of AI/ML models included in the user equipment in accordance with the environment information.

### Supplementary Note 4

The communication method according to any one of supplementary notes 1 to 3, wherein
the performing of the AI/ML processing includes performing the AI/ML processing using the environment information as input for the AI/ML model.

### Supplementary Note 5

The communication method according to any one of supplementary notes 1 to 4, further including:
receiving, by the user equipment, information permitting the user equipment to use the AI/ML model, from the network, wherein
the performing of the AI/ML processing includes performing the AI/IL processing based on the AI/ML model being permitted to be used.

### Supplementary Note 6

The communication method according to any one of supplementary notes 1 to 5, further including:
transmitting, by the user equipment, request information to the network, the request information being configured to request the environment information to be transmitted.

### Supplementary Note 7

The communication method according to any one of supplementary notes 1 to 6, further including:
receiving information, from the network, permitting the user equipment to transmit the request information, wherein
the transmitting of the request information includes transmitting the request information based on the request information being permitted to be transmitted.

### Supplementary Note 8

A communication method for applying an artificial intelligence or machine learning (AI/ML) technology to wireless communication between a user equipment and a network in a mobile communication system, the method including:
transmitting, by a user equipment, model information to a network, the model information indicating attributes of an AI/ML model included in the user equipment; and
receiving, by the user equipment, information indicating whether the user equipment is capable of using the AI/ML model, from the network.

### Supplementary Note 9

The communication method according to supplementary note 8, wherein
the model information includes at least one selected from the group consisting of information indicating a type of the AI/ML model, information indicating dependency of the AI/ML model on the network, information indicating whether to learn the AI/ML model, information indicating whether to use environment information from the network for learning processing and/or inference processing using the AI/ML model, information indicating an application of the AI/ML model, and information indicating an application environment of the AI/ML model.

### Supplementary Note 10

A communication method for applying an artificial intelligence or machine learning (AI/ML) technology to wireless communication between a user equipment and a network in a mobile communication system, the method including:
receiving, by a user equipment, configuration information from a network, the configuration information being configured to configure a transmission path used to transfer an AI/ML model from the network to the user equipment; and
receiving, by the user equipment, the AI/ML model from the network via the transmission path.

### Supplementary Note 11

The communication method according to supplementary note 10, wherein
the configuration information includes information indicating which one of a signaling radio bearer (SRB) and a data radio bearer (DRB) is configured as the transmission path.

### Supplementary Note 12

The communication method according to supplementary note 10 or 11, wherein
the configuration information includes information for identifying the signaling radio bearer (SRB) to be configured as the transmission path.

### Supplementary Note 13

The communication method according to supplementary note 10 or 11, wherein
the configuration information includes information for identifying the data radio bearer (DRB) to be configured as the transmission path and/or a transmission source address in the transmission path.

### REFERENCE SIGNS

1: Mobile communication system
5: Network
10: RAN (NG-RAN)
20: CN (5GC)
100: UE
110: Receiver
120: Transmitter
130: Controller
131: CSI generator
132: Position information generator
140: GNSS reception device
200: gNB
210: Transmitter
220: Receiver
230: Controller
231: CSI generator
240: Backhaul communicator
400: Location server
501: Communication apparatus
502: Communication apparatus

1. A communication method for applying an artificial intelligence or machine learning (AI/ML) technology to wireless communication between a user equipment and a network in a mobile communication system, the communication method comprising:
receiving, by a user equipment, environment information from a network, the environment information indicating an communication environment of a coverage area corresponding to a location of the user equipment; and
performing, by the user equipment, AI/ML processing among learning processing and/or inference processing using an AI/ML model, based on the environment information.

2. The communication method according to claim 1, wherein
the environment information comprises at least one selected from the group consisting of information indicating a density of constructions in the coverage area, information indicating a population density in the coverage area, information indicating whether the coverage area is indoors, information indicating a size of a cell comprised in the coverage area, and information indicating a height of an antenna in the cell.

3. The communication method according to claim 1, wherein
the performing of the AI/ML processing comprises selecting the AI/ML model to be used for the AI/ML processing from among a plurality of AI/ML models comprised in the user equipment in accordance with the environment information.

4. The communication method according to claim 1, wherein
the performing of the AI/ML processing comprises performing the AI/ML processing using the environment information as input for the AI/ML model.

5. The communication method according to claim 1, further comprising:
receiving, by the user equipment, information permitting the user equipment to use the AI/ML model, from the network,
wherein the performing of the AI/ML processing comprises performing the AI/ML processing based on the AI/ML model being permitted to be used.

6. The communication method according to claim 1, further comprising:
transmitting, by the user equipment, request information to the network, the request information being configured to request the environment information to be transmitted.

7. The communication method according to claim 6, further comprising:
receiving information, from the network, permitting the user equipment to transmit the request information,
wherein the transmitting of the request information comprises transmitting the request information based on the request information being permitted to be transmitted.

8. A communication method for applying an artificial intelligence or machine learning (AI/ML) technology to wireless communication between a user equipment and a network in a mobile communication system, the communication method comprising:
transmitting, by a user equipment, model information to a network, the model information indicating attributes of an AI/ML model comprised in the user equipment; and
receiving, by the user equipment, information indicating whether the user equipment is capable of using the AI/ML model, from the network.

9. The communication method according to claim 8, wherein
the model information comprises at least one selected from the group consisting of information indicating a type of the AI/ML model, information indicating dependency of the AI/ML model on the network, information indicating whether to learn the AI/ML model, information indicating whether to use environment information from the network for learning processing and/or inference processing using the AI/ML model, information indicating an application of the AI/ML model, and information indicating an application environment of the AI/ML model.

10. A communication method for applying an artificial intelligence or machine learning (AI/ML) technology to wireless communication between a user equipment and a network in a mobile communication system, the communication method comprising:
receiving, by a user equipment, configuration information from a network, the configuration information being configured to configure a transmission path used to transfer an AI/ML model from the network to the user equipment; and
receiving, by the user equipment, the AI/ML model from the network via the transmission path.

11. The communication method according to claim 10, wherein
the configuration information comprises information indicating which one of a signaling radio bearer (SRB) and a data radio bearer (DRB) is configured as the transmission path.

12. The communication method according to claim 10, wherein
the configuration information comprises information for identifying the signaling radio bearer (SRB) to be configured as the transmission path.

13. The communication method according to claim 10, wherein
the configuration information comprises information for identifying the data radio bearer (DRB) to be configured as the transmission path and/or a transmission source address in the transmission path.
